(19) United States
(12) Patent Application Publication
(10) Pub. No.: US 2026/0088458 A1
(43) Pub. Date: Mar. 26, 2026

(54) Battery Apparatus and Manufacturing Apparatus of Battery Apparatus and Manufacturing Method of Battery Apparatus

(71) Applicant: SK On Co., Ltd., Seoul (KR)

(72) Inventors: In Seob KANG, Daejeon (KR); Ji Sang YOON, Daejeon (KR)

(21) Appl. No.: 19/223,622

(22) Filed: May 30, 2025

(30) Foreign Application Priority Data
Sep. 24, 2024 (KR) 10-2024-0128808

(51) Int. Cl. H01M 50/516; H01M 10/04; H01M 10/48; H01M 50/211; H01M 50/262; H01M 50/289; H01M 50/507

(52) U.S. Cl. CPC H01M 50/516; H01M 10/0404; H01M 10/482; H01M 50/211; H01M 50/262; H01M 50/289; H01M 50/507

(57) ABSTRACT

A battery apparatus according to an embodiment of the present disclosure may include: a plurality of battery cells respectively including a plurality of electrode leads; a busbar assembly connected to the plurality of electrode leads of the plurality of battery cells; and a case covering the plurality of battery cells and the busbar assembly, and the busbar assembly may include: a busbar member in contact with the plurality of electrode leads; and an insulating member in which one surface thereof is in contact with the busbar member and the other surface faces the case.

### CROSS-REFERENCE TO RELATED APPLICATION(S)

This patent document claims the priority and benefits of Korean Patent Application No. 10-2024-0128808 filed on Sep. 24, 2024, the disclosure of which is incorporated herein by reference in its entirety.

### TECHNICAL FIELD

The present disclosure relates to a battery apparatus and a manufacturing apparatus of a battery apparatus and a manufacturing method of a battery apparatus.

### BACKGROUND

Batteries are widely used not only in small electronic devices such as mobile phones and laptop computers, but also in medium and large mechanical devices such as electric vehicles (EVs) and energy storage devices, and have the advantage of being rechargeable and reusable.

An electrode assembly including a cathode plate and an anode plate may be stored in a case selected according to the purpose of use, such as a pouch type, square type, or cylindrical type, and an electrolyte may be injected to manufacture a battery cell.

A battery apparatus may be configured by connecting a plurality of battery cells to a bus bar. The battery apparatus may be, for example, a battery module and/or a battery pack.

The bus bar may be connected to an electrode lead of the battery cell. The electrode lead of the battery cell may include a cathode lead connected to the cathode plate and an anode lead connected to the anode plate.

### SUMMARY

According to an aspect of the present disclosure, a battery apparatus having improved connection reliability between a busbar and an electrode lead is provided, and a manufacturing apparatus of the battery apparatus having improving connection reliability between the busbar and the electrode lead and a manufacturing method of the battery apparatus are provided.

Additionally, according to an aspect of the present disclosure, a battery apparatus having improved insulation performance and energy density is provided, and a manufacturing apparatus for manufacturing the battery apparatus having improved insulation performance and energy density and a manufacturing method thereof are provided.

Additionally, the present disclosure may be widely applied to devices within green technology fields such as solar power generation and wind power generation.

Additionally, the present disclosure may be applied to eco-friendly devices such as eco-friendly electric vehicles and hybrid vehicles for ameliorating the effects of climate change by suppressing air pollution and greenhouse gas emissions.

A battery apparatus according to an embodiment of the present disclosure may include: a plurality of battery cells respectively including a plurality of electrode leads; a busbar assembly connected to the plurality of electrode leads of the plurality of battery cells; and a case covering the plurality of battery cells and the busbar assembly, and the busbar assembly may include: a busbar member in contact with the plurality of electrode leads; and an insulating member in which one surface thereof is in contact with the busbar member and the other surface faces the case.

In an embodiment, a contact region in which the busbar member is in contact with the plurality of electrode leads may not face the case.

In an embodiment, the case and the busbar member may be spaced apart from each other with the insulating member interposed therebetween.

In an embodiment, the plurality of battery cells may be arranged so that a plurality of electrode leads of one battery cell face a plurality of electrode leads of the other battery cell adjacent to the one battery cell, and the busbar members may be provided in plural, and one busbar member may be in contact with one electrode lead of the one battery cell and one electrode lead of the other battery cell.

In an embodiment, the insulating members may be provided in plural, and one insulating member may be in contact with one busbar member.

In an embodiment, a plurality of busbar members may be spaced apart from each other, and a plurality of insulating members may be spaced apart from each other.

In an embodiment, the busbar member may include: a first body region including the contact region; and a first extension region bent and extending from the first body region, and the insulating member may include: a second body region in contact with the first body region; and a second extension region bent and extending from the second body region and supporting the first extension region.

In an embodiment, the battery apparatus may further include: a sensing assembly in contact with the first extension region.

In an embodiment, the sensing assembly may include: a sensing terminal in contact with the first extension region; and a substrate connected to the sensing terminal and disposed so that at least a partial region of the sensing terminal faces a side sealing portion of the plurality of battery cells.

In an embodiment, the insulating member may further include: a third extension region bent and extending from the second body region, and spaced apart from the second extension region to face the second extension region, and the insulating member may further include a fastening member connecting the third extension region and the case.

In an embodiment, the insulating member may further include: a through-hole formed in the third extension region; and an insulating ring inserted into the through-hole and including a hollow portion, and the fastening member may be fixed to the case by penetrating through the hollow portion of the insulating ring.

In an embodiment, the plurality of battery cells may be provided so that the plurality of electrode leads are bent.

In an embodiment, the busbar assembly may further include: an outer busbar member in contact with an electrode lead of a battery cell disposed in an outermost portion of one side, among the plurality of battery cells, and an electrode lead of a battery cell disposed in an outermost portion of the other side; and a side insulating member supporting the outer busbar member.

Meanwhile, the present disclosure of another aspect provides a manufacturing apparatus of a battery apparatus. The manufacturing apparatus of a battery apparatus of an embodiment of the present disclosure may include: a welding device welding an electrode lead of one battery cell, among a plurality of battery cells, and an electrode lead of the other battery cell to a busbar member; and a folding device including a jig member disposed to face the electrode lead of the one battery cell and the electrode lead of the other battery cell, and moving at least one of the one battery cell or the other battery cell;

In an embodiment, the folding device may move at least one of the one battery cell or the other battery cell so that the electrode lead of the one battery cell and the electrode lead of the other battery cell are in contact with the jig member.

In an embodiment, the folding device may move at least one of the one battery cell or the other battery cell so that the one battery cell and the other battery cell are adjacent to each other.

In an embodiment, a width of the jig member is widest on a surface in contact with the electrode lead and is reduced in a direction away from the electrode lead.

A manufacturing method of a battery apparatus according to an embodiment of the present disclosure may include: a welding operation of welding a busbar member to a plurality of battery cells respectively including a plurality of electrode leads; and a folding operation of moving at least one battery cell to bend at least one of the plurality of electrode leads, and stacking the plurality of battery cells in a thickness direction of the plurality of battery cells.

According to an aspect of the present disclosure, a battery apparatus having improved connection reliability between a busbar and an electrode lead may be provided, and a manufacturing apparatus of the battery apparatus having improving connection reliability between the busbar and the electrode lead and a manufacturing method of the battery apparatus may be provided.

Additionally, according to an aspect of the present disclosure, a battery apparatus having improved insulation performance and energy density, and a manufacturing apparatus for manufacturing the battery apparatus having improved insulation performance and energy density and a manufacturing method thereof may be provided.

Additionally, the present disclosure may be widely applied to devices within green technology fields such as solar power generation and wind power generation.

Additionally, the present disclosure may be applied to eco-friendly devices such as eco-friendly electric vehicles and hybrid vehicles for ameliorating the effects of climate change by suppressing air pollution and greenhouse gas emissions.

### BRIEF DESCRIPTION OF DRAWINGS

Certain aspects, features, and advantages of the present disclosure are illustrated by the following detailed description with reference to the accompanying drawings.

FIG. 1 is a schematic exploded perspective view of a battery apparatus based on an embodiment of the present disclosure.

FIG. 2 is a schematic exploded perspective view of a plurality of battery cells and a busbar assembly of FIG. 1.

FIG. 3 is an enlarged view illustrating a state in which a busbar member and a plurality of electrode leads are in contact with each other.

FIG. 4 is a plan view schematically illustrating a portion of a plurality of battery cells, a busbar assembly, and a case based on an embodiment of the present disclosure.

FIG. 5 is a schematic exploded perspective view of a busbar assembly based on an embodiment of the present disclosure.

FIG. 6 is a schematic exploded perspective view of a plurality of battery cells and an upper portion of a busbar assembly based on an embodiment of the present disclosure, and illustrates a connection state between a sensing assembly and a busbar assembly.

FIG. 7 is a schematic exploded perspective view of a battery cell based on an embodiment of the present disclosure.

FIG. 8 is a schematic exploded perspective view of an insulating member based on another embodiment of the present disclosure.

FIG. 9 is a plan view schematically illustrating a state in which the insulating member illustrated in FIG. 8 is connected to a battery cell.

FIG. 10 is a cross-sectional view schematically illustrating a state in which the insulating member illustrated in FIG. 8 is fixed to a case.

FIG. 11 is a schematic illustration of a bottom surface of the case illustrated in FIG. 10.

FIG. 12 is a schematic illustration of a portion of a battery apparatus welded by a welding device of a manufacturing apparatus of a battery apparatus based on an embodiment of the present disclosure.

FIG. 13 is a schematic illustration of a portion of a battery apparatus folded by a folding device of a manufacturing apparatus of a battery apparatus based on an embodiment of the present disclosure.

FIG. 14 is a schematic illustration of a manufacturing process of a manufacturing apparatus of a battery apparatus.

FIG. 15 is an operational state diagram schematically illustrating a state in which a folding device based on an embodiment of the present disclosure moves a plurality of battery cells to fold a plurality of electrode leads.

FIG. 16 is a schematic illustration of a state in which a folding device based on another embodiment of the present disclosure moves a plurality of battery cells to fold a plurality of electrode leads.

FIG. 17 schematically illustrates a battery cell assembly manufactured by a manufacturing apparatus of a battery apparatus based on another embodiment of the present disclosure.

FIG. 18 schematically illustrates a method of manufacturing a battery apparatus according to an embodiment of the present disclosure.

### DETAILED DESCRIPTION

In order to help understand the description of an embodiment of the present disclosure, elements described with the same symbol in the attached drawings are the same elements. Some components of the attached drawings are exaggerated, omitted, or schematically illustrated, and sizes of each component does not completely reflect actual sizes.

Additionally, in order to clarify the gist of the present disclosure, descriptions of elements and techniques well known by conventional techniques will be omitted, and hereinafter, the present disclosure will be described in detail with reference to the attached drawings.

Hereinafter, an X-axis illustrated in the attached drawing below is a thickness direction of a battery cell 110 or a stacking direction of a plurality of battery cells 110, a Y-axis is a width direction of the battery cell 110, and a Z-axis is a height direction of the battery cell 110.

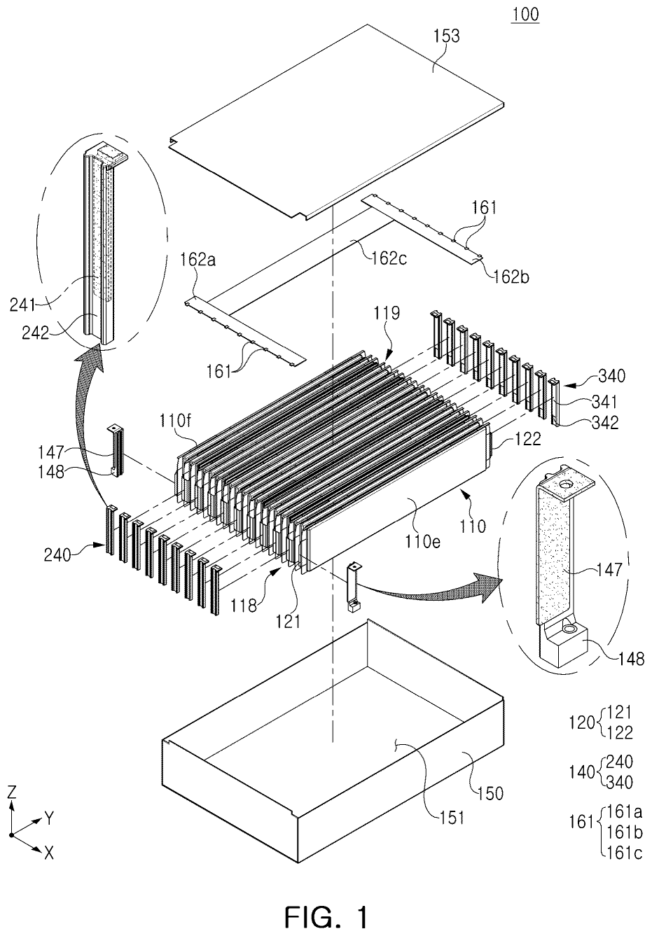

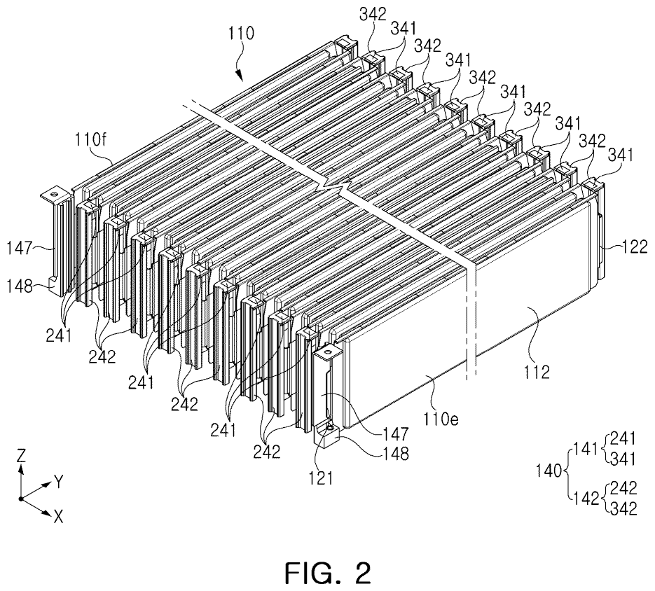

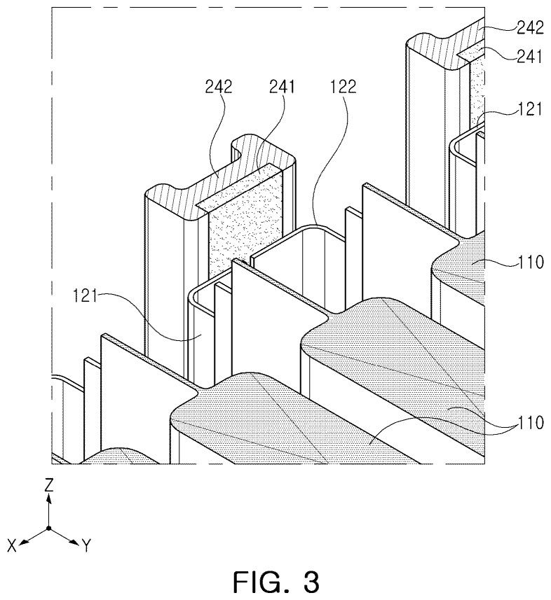

FIG. 1 is a schematic exploded perspective view of a battery apparatus 100 based on an embodiment of the disposed technology, FIG. 2 is a perspective view schematically illustrating a plurality of battery cells 110 and a busbar assembly 140 of FIG. 1, and FIG. 3 is an enlarged view illustrating a state in which a busbar member 141 and a plurality of electrode leads 120 are in contact with each other.

As shown in FIGS. 1 to 3, a battery apparatus 100 according to an embodiment of the present disclosure may include a plurality of battery cells 110 respectively including a plurality of electrode leads 120, a bus bar assembly 140 connected to the plurality of electrode leads 120 of the plurality of battery cells 110, and a case 150 covering the plurality of battery cells 110 and the bus bar assembly 140, and the bus bar assembly 140 may include a bus bar member 141 in contact with the plurality of electrode leads 120, and an insulating member 142 in which one surface thereof is in contact with the bus bar member 141 and the other surface thereof facing the one surface faces the case 150.

A single battery cell 110 may include a plurality of electrode leads 120. For example, the battery cell 110 may have an electrode assembly accommodated inside an outer material 111. The electrode assembly may include a cathode plate and an anode plate, and the cathode plate and the anode plate may be separated from each other by a separator. An electrolyte may be accommodated inside the outer material 111 together with the electrode assembly.

The outer material 111 may seal a space in which the electrode assembly and the electrolyte are accommodated. In this case, a plurality of electrode leads 120 connected to the cathode plate and the anode plate may be withdrawn or exposed to at least one edge of the outer material 111.

In an embodiment, the plurality of electrode leads 120 may include a cathode lead 121 connected to the cathode plate and an anode lead 122 connected to the anode plate.

The battery cell 110 according to an embodiment of the present disclosure may be a lithium ion battery, may be a pouch-type battery cell 110, and may be a bidirectional battery cell 110 in which the plurality of electrode leads 120 are withdrawn or exposed in different directions from the outer material 111.

The bidirectional battery cell 110 may be a battery cell 110 in which the plurality of electrode leads 120 are withdrawn or exposed to different corners or different edges of the outer material 111. Specific details regarding the bidirectional battery cell 110 will be described below.

In addition to the pouch type, the type of the battery cell 110 may be replaced with a square or cylindrical type, and the plurality of electrode leads 120 may be provided in a shape suitable for each type of battery cell 110.

Hereinafter, the bidirectional battery cell 110 will be described as an example. Additionally, a case in which the plurality of battery cells 110 are connected in series will be described as an example. However, the plurality of battery cells 110 may be connected in parallel, or a combination of serial connection and parallel connection may be used.

The plurality of battery cells 110 may be formed by providing the plurality of battery cells 110. In an embodiment, the plurality of battery cells 110 may be arranged or stacked so that the electrode leads 120 of each battery cell 110 face each other, and respective electrode assembly accommodation spaces 112 face each other.

In an embodiment, in a pair of adjacent battery cells 110, the cathode lead 121 may face the anode lead 122. For example, when viewed in one side surface (+Y-direction, 118) of the pair of battery cells 110, the cathode lead 121 of one battery cell 110 may face the anode lead 122 of the other battery cell 110 adjacent to the one battery cell 110 in a thickness direction (X-direction) of the battery cell 110. In this case, when viewed in the other side surface (−Y-direction, 119) of the pair of battery cells 110, the anode lead 122 of one battery cell 110 may face the cathode lead 122 of the other battery cell 110 adjacent to the one battery cells 110 in the thickness direction (X-direction) of the battery cell 110. This may be a case in which the plurality of battery cells 110 are connected in series.

However, in FIG. 1, the case in which the plurality of battery cells 110 are connected in series is illustrated, but in another embodiment of the present disclosure, the plurality of battery cells 110 may be disposed so that the cathode lead 121 of one battery cell 110 faces a cathode lead 121 of another adjacent battery cell 110. In this case, the cathode lead 121 and another cathode lead 122 may face each other in the thickness direction of the battery cell 110. This may be a case in which the plurality of battery cells 110 are connected in parallel.

As shown in FIG. 1, in an embodiment of the present disclosure, the plurality of battery cells 110 may be disposed so that the cathode lead 121 of one battery cell 110 faces the anode lead 122 of the other battery cell 110 adjacent to the one battery cell 110 in a direction in which the plurality of battery cells 110 are stacked (X-direction).

Accordingly, the anode lead 122 of one battery cell 110 may face the cathode lead 121 of the other battery cell 110 adjacent to the one battery cell 110.

On one side surface 118 of the plurality of battery cells 110, the cathode leads 121 and the anode leads 122 of the plurality of battery cells 110 may be alternately disposed in the stacking direction (X-direction) of the plurality of battery cells 110. In this case, one first bus bar member 241 may connect the cathode lead 121 and the anode lead 122 of a pair of neighboring battery cells 110.

Additionally, a second bus bar member 341 may connect the cathode lead 121 of one of the battery cells 110 adjacent to each other and the anode lead 122 of the other battery cell 110. In this case, the plurality of battery cells 110 may be connected in series.

However, whether the plurality of battery cells 110 are connected in series or in parallel is not necessarily limited by the present disclosure.

The plurality of battery cells 110 may be arranged or stacked so that the electrode assembly accommodation spaces 112 face each other. In this case, a direction in which the electrode assembly accommodation spaces 112 of the plurality of battery cells 110 face each other may be the thickness direction of the battery cell 110. The plurality of battery cells 110 may be stacked in the thickness direction of the battery cell 110.

In an embodiment, the plurality of battery cells 110 may be arranged so that a plurality of electrode leads 120 of one battery cell 110 face a plurality of electrode leads 120 of the other battery cell 110 adjacent to the one battery cell 110. Here, the plurality of electrode leads 120 of one battery cell 110 may include a cathode lead 121 and an anode lead 122 of the one battery cell 110. Additionally, the plurality of electrode leads 120 of the other battery cell 110 may include a cathode lead 121 and an anode lead 122 of the other battery cell 110.

The cathode lead 121 of the one battery cell 110 and the anode lead 122 of the other battery cell 110 may face each other. In this case, the cathode lead 121 and the anode lead 122 may face each other and/or be stacked in an X-axis direction.

The number of the plurality of battery cells 110 is not necessarily limited by the present disclosure, but the plurality of battery cells 110 may be stacked and/or arranged in the above-described manner. The plurality of battery cells 110 may be disposed in parallel in the thickness direction (X-direction) of the battery cell 110.

In this case, the busbar member 141 of the busbar assembly 140 may be provided in plural. Additionally, in an embodiment, one busbar member 141 may be in contact with one electrode lead 120 of one battery cell 110 and one electrode lead 120 of the other battery cell 110 adjacent to the one battery cell 110.

For example, on one side surface 118 of the battery cell 110, the cathode lead 121 of one battery cell 110 and the anode lead 122 of the other battery cell 110 adjacent to the one battery cell 110 may be in contact with one busbar member 141.

Similarly, on the other side surface 119 of the battery cell 110, the cathode lead 121 of one battery cell 110 and the anode lead 122 of the other battery cell 110 adjacent to the one battery cell 110 may be in contact with one busbar member 141.

Additionally, as an example, one bus bar member 141 may be in contact with a pair of electrode leads 120 on one side surface 118 of the plurality of battery cells 110, and another bus bar member 141 may be in contact with the pair of electrode leads 120 on the other side surface 119 of the plurality of battery cells 110. The electrical polarity of the pair of electrode leads 120 is not necessarily limited by the present disclosure.

In an embodiment of the present disclosure, the busbar assembly 140 connecting the pair of electrode leads 120 on one surface side surface 118 of the plurality of battery cells 110 may be a first busbar assembly 240, and the busbar assembly 140 connecting the pair of electrode leads 120 on the other side surface 119 of the plurality of battery cells 110 may be a second busbar assembly 340. However, this is according to an embodiment, and the electrical polarity of the electrode leads 120 connected to the first busbar assembly 240 and the second busbar assembly 340 may be determined depending on whether the plurality of battery cells 110 are connected in series and/or in parallel.

In an embodiment, the first busbar assembly 240 may include a plurality of first busbar members 241 connecting the cathode lead 121 and the anode lead 122 on one side surface 118 of the plurality of battery cells 110 and a plurality of first insulating members 242 supporting the plurality of first busbar members 241, and the second busbar assembly 340 may include a plurality of second busbar members 341 connecting the anode lead 122 and the cathode lead 121 on the other side surface 119 of the plurality of battery cells 110 and a plurality of second insulating members 342 supporting the plurality of second busbar members 341. For example, one first bus bar member 241 may connect the cathode lead 121 and the anode lead 122 on one side surface 118 of the plurality of battery cells 110, and one second bus bar member 341 may connect the cathode lead 121 and the anode lead 122 on the other side surface 119 of the plurality of battery cells 110.

In an embodiment, at least one pad member 130 may be provided between each of the plurality of battery cells 110. The pad member 130 may be intermittently interposed between each of the plurality of battery cells 110. The pad member 130 may provide surface pressure to the battery cells 110 or may perform heat transfer. For example, the pad member 130 may be formed of a material including mica (MICA), but this is not necessarily limited by the present disclosure. According to the pad member 130, the usability stability and cooling performance of the battery apparatus 100 may be improved.

The bus bar assembly 140 may be electrically connected to the cathode lead 121 and the anode lead 122. The bus bar assembly 140 may be provided in plural.

Meanwhile, in another embodiment of the present disclosure, when the first bus bar assembly 240 connects the electrode leads 120 having the same polarity and the second bus bar assembly 340 connects the electrode leads 120 having the same polarity, the first bus bar assembly 240 may be electrically connected to the plurality of cathode leads 121 on one side surface 118 of the plurality of battery cells 110. Additionally, the second bus bar assembly 340 may be electrically connected to the plurality of anode leads 122 on the other side surface 119 of the plurality of battery cells 110.

In an embodiment, the first bus bar assembly 240 may face an end of the electrode lead 120 in a width direction (−Y-direction) of the battery cell 110 on one side surface 118 of the plurality of battery cells 110, and the second bus bar assembly 340 may face an end of the electrode lead 120 in a width direction (+Y-direction) of the battery cell 110 on the other side surface 119 of the plurality of battery cells 110.

The first bus bar assembly 240 may be disposed on one side surface 118 of the battery cell 110, and the second bus bar assembly 340 may be disposed on the other side surface 119 of the battery cell 110. The one side surface 118 of the battery cell 110 may be a plane on which an end of the cathode lead 121 (or the anode lead 122) of the battery cell 110 is disposed, and the plane may be a plane (e.g., an X-Z plane) that is parallel to the thickness direction of the battery cell 110.

In an embodiment, the other side surface 119 of the battery cell 110 may be a plane on which the end of the anode lead 122 (or the cathode lead 121) of the battery cell 110 is disposed, and the plane may be a plane (e.g., the X-Z plane) that is parallel to the thickness direction of the battery cell 110.

Based on one battery cell 110, a plane from which one electrode lead 120 is withdrawn may be one side surface 118 of the battery cell 110, and a plane from which another electrode lead 120 is withdrawn may be the other side surface 119 of the battery cell 110. In this case, based on one battery cell 110, an electrical polarity of the electrode lead 120 withdrawn to one side surface 118 of the battery cell 110 and an electrical polarity of the electrode lead 120 withdrawn to the other side surface 119 of the battery cell 110 may be different from each other.

The one side surface 118 and the other side surface 119 of the battery cell 110 may be planes that are parallel to each other. The battery cell 110 may be disposed between the one side surface 118 and the other side surface 119 of the battery cell 110. A plurality of battery cells 110 may be interposed between the first busbar assembly 240 and the second busbar assembly 340. For example, the plurality of battery cells 110 may be disposed between the first busbar assembly 240 and the second busbar assembly 340 in a Y-axis.

The case 150 may include an accommodation space 151. The plurality of battery cells 110, the first busbar assembly 240 and the second busbar assembly 340 may be accommodated in the accommodation space 151. The case 150 is not limited in shape or material as long as the case may accommodate the plurality of battery cells 110, the first busbar assembly 240 and the second busbar assembly 340.

For example, the case 150 may be a box shape including the accommodation space 151, but this is only an embodiment, and the case 150 may also be comprised of a combination of a plurality of plates. When the case 150 is comprised of a plurality of plates, the plurality of plates may surround or cover one side surface 118 and the other side of the plurality of battery cells 110. In this case, the plurality of plates may also surround or cover the first busbar assembly 240 and the second busbar assembly 340.

In an embodiment, the first busbar assembly 240 may include the busbar member 141 and the insulating member 142. Additionally, as an example, the first busbar assembly 240 may include a plurality of busbar members 141 and a plurality of insulating members 142.

The first busbar assembly 240 may include a first busbar member 241 electrically connected to the pair of electrode leads 120 and a first: insulating member 242 supporting the first busbar member 241. Each of the first busbar member 241 and the first insulating member 242 may be provided in plural.

The first insulating member 242 may be provided in the same number as the number of the first busbar members 241. One first insulating member 242 may support one first busbar member 241.

The first busbar member 241 may be formed of an electrically conductive material. The first busbar member 241 may be welded to the pair of electrode leads 120. However, a method other than welding may be applied to connect the electrode lead 120 and the busbar member 141.

In an embodiment, a cathode lead 121 and an anode lead 122 may be connected to one first busbar member 241. For example, a cathode lead 121 and a anode lead 122 of a pair of battery cells 110 that are adjacent to each other and in which electrode assembly accommodation spaces 112 thereof face each other may be connected to one first busbar member 241. One first busbar member 241 may be provided for each pair of battery cells 110.

The matters related to the first busbar assembly 240 described above may be applied to the second busbar assembly 340 in the same principle. The second busbar assembly 340 may include the second busbar member 341 connected to the pair of electrode leads 120 and the second insulating member 342 supporting the second busbar member 341. The second busbar member 341 may be formed of an electrically conductive material. Additionally, the second busbar member 341 and the second insulating member 342 may be provided in plural.

The anode lead 122 and the cathode lead 121 of the pair of battery cells 110 adjacent to each other may be connected to one second busbar member 341. That is, the pair of electrode leads 120 may be connected to one second busbar member 341.

The second insulating member 342 may be provided in the same number as the number of second busbar members 341. One second insulating member 342 may support one second busbar member 341.

One battery cell 110 may include an electrode assembly accommodation space 112 and a plurality of electrode leads 120. Accordingly, the plurality of battery cells 110 may be stacked so that each electrode assembly accommodation space 112 faces each other and each electrode lead 120 faces each other.

Accordingly, in a plurality of stacked battery cells 110, the plurality of electrode assembly accommodation space 112 may be interposed between each of the plurality of electrode leads 120. In this case, the plurality of electrode assembly accommodation spaces 112 may be interposed between each of the plurality of electrode leads 120 in a width direction (Y-direction) of the battery cell 110.

Based on one battery cell 110, the cathode lead 121 and the anode lead 122 may not face each other or may be spaced apart from each other in the width direction (Y-direction) of the battery cell 110. The cathode lead 121 and the anode lead 122 may be isolated or spaced apart from each other in the width direction (Y-direction) of the battery cell 110 by the electrode assembly accommodation spaces 112.

The plurality of first busbar members 241 may be spaced apart from each other in the width direction (Y-direction) of the battery cell 110 with the plurality of second busbar members 341 and the electrode assembly accommodation space 112 interposed therebetween. The plurality of first busbar members 241 and the plurality of second busbar members 341 may not face each other in the width direction (Y-direction) of the battery cell 110. Additionally, the plurality of first insulating members 242 and the plurality of second insulating members 342 may also be spaced apart from each other in the width direction (Y-direction) of the battery cell 110, and may not face each other.

The plurality of first busbar members 241 and the plurality of first insulating members 242 may be disposed on one side surface 118 of the battery cell 110, and the plurality of second busbar members 341 and the plurality of second insulating members 342 may be disposed on the other side surface 119 of the battery cell 110.

At least a partial region of the case 150 may be arranged on one side surface 118 and the other side surface 119 of the battery cell 110. At least a partial region of the case 150 may face the first insulating member 242 on one side surface 118 of the battery cell 110, and at least a partial region of the remaining region of the case 150 excluding the at least a partial region may face the second insulating member 342 on the other side surface 119 of the battery cell 110.

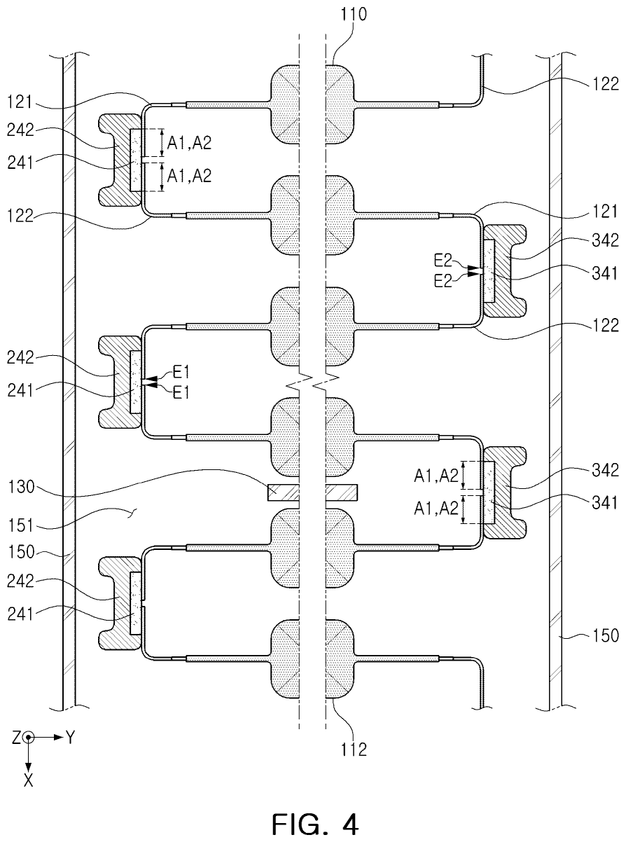

FIG. 4 is a plan view schematically illustrating a portion of a plurality of battery cells 110, a busbar assembly 140, and a case 150 based on an embodiment of the present disclosure.

As shown in FIGS. 1 to 4, a contact region A1 which is a region in which the cathode lead 121 and the anode lead 122 are in contact with each other may be provided in one first busbar member 241. Accordingly, each of the plurality of first busbar members 241 may include the contact region A1. Additionally, a second busbar member 341 may also be provided with a contact region A1, which is a region in which an anode lead 122 and a cathode lead 121 are in contact with each other. Accordingly, each of the plurality of second busbar members 341 may include the contact region A1.

A plurality of first busbar members 241 and a plurality of second busbar members 341 may be disposed to be misaligned with each other in the thickness direction of the battery cell 110. In a cross-section (X-Y plane) of the battery cell 110 in the thickness direction, the first busbar members 241 and the second busbar members 341 may not face each other in the width direction (Y-direction) of the battery cell. Additionally, in the cross-section (e.g., X-Y plane) of the battery cell 110 in the thickness direction, the first busbar members 241 and the second busbar members 341 may not exist on the same line in the width direction (Y-direction) of the battery cell.

In an embodiment of the present disclosure, the contact region A1, which is a region in which a busbar member 141 is in contact with the plurality of electrode leads 120, may not face the case 150. For example, the contact region A1 of the busbar member 141 and the plurality of electrode leads 120 may not face the case 150. Additionally, as an example, the contact region A1 in which the busbar member 141 is in contact with the plurality of electrode leads 120 may be disposed on an opposite side of the case 150.

For example, the contact region A1 of one first busbar member 241 and two electrode leads 120 may not face the case 150. That is, the contact region A1 of one first busbar member 241 and two electrode leads 120 may be non-face-to-face with the case 150. Accordingly, not all of the contact regions A1 with the electrode leads 120 formed on the plurality of first busbar members 241 may face the case 150. This may be applied to the second busbar member 341 and the electrode lead 120 that contacts the second busbar member 341 in the same principle.

As described above, since the contact region A1 does not face the case 150, the case 150 and the busbar member 141 may be spaced apart from each other with the insulating member 142 interposed therebetween.

For example, the first busbar member 241 may be spaced apart from the case 150 in the width direction (Y-direction) of the battery cell 110 with the first insulating member 242 interposed therebetween. The first busbar member 241 may not face the case 150 in the width direction (Y-direction or −Y-direction) of the battery cell 110.

The second bus bar member 341 may also be spaced apart from the case 150 in the width direction (Y-direction) of the battery cell 110 with the second insulating member 342 interposed therebetween. The second bus bar member 341 may not face the case 150 and the battery cell 110 in the width direction (Y-direction or +Y-direction).

Additionally, in an embodiment, the insulating member 142 may be formed of a material having electrical insulation properties. For example, the insulating member 142 may be an engineering plastic. For example, the insulating member 142 may include at least one of Modified Polyphenylene Oxide (mPPO), polypropylene (PP) and (Acrylonitrile, Butadiene, Styrene (ABS). According to the material of the insulating member 142 as described above, the formability, dimensional stability, and strength of the insulating member 142 may be improved. However, the material of the insulating member 142 may be replaced with a material other than the aforementioned material.

In an embodiment, the insulating member 142 may include the first insulating member 242 and the second insulating member 342, and the aforementioned materials may also be applied to materials of the first insulating member 242 and the second insulating member 342. The materials of the first insulating member 242 and the second insulating member 342 may be applied differently or identically.

In an embodiment, the first busbar member 241 and the first insulating member 242 may be subject to insert-injection, and the second busbar member 341 and the second insulating member 342 may also be subject to insert-injection. However, this is according to an embodiment of the present disclosure, and a manufacturing method of the busbar assembly 140 may be replaced with another method.

Additionally, in an embodiment, the insulating member 142 may be provided in plural, and one insulating member 142 may be in contact with one busbar member 141. The number of insulating members 142 and the number of busbar members 141 may be identical to each other. Additionally, as an example, the insulating members 142 and the busbar members 141 may correspond to each other 1:1.

Additionally, in an embodiment, the plurality of busbar members 141 may be spaced apart from each other, and the plurality of insulating members 142 may also be spaced apart from each other. In this case, a separation direction may be at least one of the thickness direction (X-direction) and the width direction (Y-direction) of the battery cell 110.

Specifically, the first busbar assembly 240 may include a plurality of first insulating members 242. The plurality of first insulating members 242 may be spaced apart from each other in the thickness direction (X-direction) of the battery cell 110. The plurality of first insulating members 242 may be independent members. The plurality of first insulating members 242 may be not in contact with each other.

Additionally, the first busbar assembly 240 may include a plurality of first busbar members 241. The plurality of first busbar members 241 may be spaced apart from each other in the thickness direction (X-direction) of the battery cell 110. The plurality of first busbar members 241 may be independent members. The plurality of first busbar members 241 may not be in contact with each other. As described above, a pair of cathode leads 121 may be in contact with one first busbar member 241. A contact region A1 may be formed in one first bus bar member 241, and the contact region A1 may be a region in which the first bus bar member 241 and a pair of electrode leads 120 come into contact.

One first insulating member 242 may be in contact with one first bus bar member 241, and one first insulating member 242 may support one first bus bar member 241. A plurality of bus bar members 141 may be independently supported by a plurality of insulating members 142.

The contact region A1 may be spaced apart from an inner surface of the case 150 in the width direction (Y-direction) of the battery cell 110, and the contact region A1 may not face the inner surface of the case 150 in the width direction (Y-direction) of the battery cell 110.

A first insulating member 242 may be interposed between the contact region A1 and the case 150. The first insulating member 242 may be in contact with the first busbar member 241 and may support the first busbar member 241. In some cases, the first insulating member 242 may further be provided with a venting hole through which gas may flow, but this is not necessarily limited by the present disclosure.

The above-described matters may be applied to the second busbar assembly 340 in the same principle. The second busbar assembly 340 may include a plurality of second insulating members 342. The plurality of second insulating members 342 may be spaced apart from each other in the thickness direction (X-direction) of the battery cell 110. The plurality of second insulating members 342 may be independent members. The plurality of second insulating members 342 may not be in contact with each other.

Additionally, the second busbar assembly 340 may include a plurality of second busbar members 341. The plurality of second busbar members 341 may be spaced apart from each other in the thickness direction (X-direction) of the battery cell 110. The plurality of second busbar members 341 may be independent members. The plurality of second busbar members 341 may not be in contact with each other.

A pair of electrode leads 120 may be in contact with one second busbar member 341. A contact region A1 may be formed in one second busbar member 341, and the contact region A1 may be a region in which the second busbar member 341 and the pair of electrode leads 120 come into contact.

However, the first bus bar assembly 240 may be disposed on the other side surface 119 of the battery cell 110, and the second bus bar assembly 340 may be placed on one side surface 118 of the battery cell 110. That is, the first bus bar assembly 240 and the second bus bar assembly 340 may be applied interchangeably with each other.

Additionally, in an embodiment, the anode lead 122 of one battery cell 110 may be connected to the first bus bar member 241, and the cathode lead 121 may be connected to the second bus bar member 341. Additionally, the anode lead 122 of the other battery cell 110 adjacent to the one battery cell 110 may be connected to the second bus bar member 341, and the cathode lead 121 of the other battery cell 110 may be connected to another first bus bar member 241. A plurality of battery cells 110 may be connected to a plurality of first bus bar members 241 and a plurality of second bus bar members 341 by this principle.

One surface of the bus bar member 141 may be in contact with the electrode lead 120, and the other surface opposite to the one surface may be in contact with the insulating member 142. The one surface of the bus bar member 141 may be in contact with the case 150, and the one surface may be spaced apart from the case 150 and may not be in contact with the case 150.

According thereto, the case 150 and the busbar member 141 may be electrically insulated by the insulating member 142. Accordingly, a space between one side surface 118 of the plurality of battery cells 110 and the case 150, and between the other side surface 119 of the plurality of battery cells 110 and the case 150 may be maintained as an empty space. This space may be utilized as a space for venting gas in some cases. Alternatively, other components for an operation of the battery apparatus 100 may be disposed in this space.

That is, the present disclosure may electrically connect the plurality of battery cells 110 by the busbar assembly 140, and may also insulate the plurality of battery cells 110 from the case 150. This allows the battery apparatus 100 to exclude a separate component for side insulation of the battery cell 110, and contributes to improving the space efficiency and energy density of the battery apparatus 100.

In another embodiment of the present disclosure, an inner surface of the case 150 may be in contact with the insulating member 142. This is a matter that may be selected and applied according to the design specifications of the battery apparatus 100. However, the battery apparatus 100 of the present disclosure may include an insulating member 142 supporting the busbar member 141 connected to the electrode lead 120, and the insulating member 142 may support the busbar member 141 and may electrically insulate the busbar member 141 and the case 150 at the same time.

Additionally, in an embodiment, in the plurality of battery cells 110, a plurality of electrode leads 120 may be bent. For example, the plurality of battery cells 110 may be bent in a direction in which the plurality of electrode leads 120 face the busbar member 141.

For example, the electrode leads 120 of each of a pair of battery cells 110 adjacent to each other may be bent in a direction in which the electrode leads 120 come closer to each other.

That is, one cathode lead 121 may be bent in a direction oriented toward the anode lead 122 adjacent to the one cathode lead 121.

Additionally, on one side surface 118 of the plurality of battery cells 110, a coupling region A2 including a first end E1 of the electrode lead 120 may be in contact with the busbar member 141. The contact region A1 formed on the busbar member 141 may be a region in which the coupling region A2 and the busbar member 141 are in contact with each other. For example, an area of the coupling region A2 may be the same as an area of the contact region A1. The coupling region A2 may be formed on a pair of electrode leads 120 in contact with the busbar member 141, and the coupling region A2 may include a first end E1 and a second end E2 of the electrode leads 120. The second end E2 of the electrode leads 120 may be an end of the electrode leads 120 withdrawn to the other side surface 119 of the plurality of battery cells 110.

According thereto, the electrode leads 120 may be insulated from the case 150. Additionally, the utilization of a side space of the battery apparatus 100 may be improved. Additionally, the busbar member 141 may be supported only by the insulating member 142 without a separate part. Additionally, the electrode lead 120 and the busbar member 141 may be insulated from the case 150 only by the insulating member 142.

Additionally, the contact region A1 may be formed in plural, and the plurality of contact regions A1 may be continuous in a stacking direction of the plurality of battery cells 110 or a thickness direction (X-direction) of the battery cells 110. Additionally, the plurality of contact regions A1 may be disposed in parallel in the stacking direction of the plurality of battery cells 110 or the thickness direction (X-direction) of the battery cells 110.

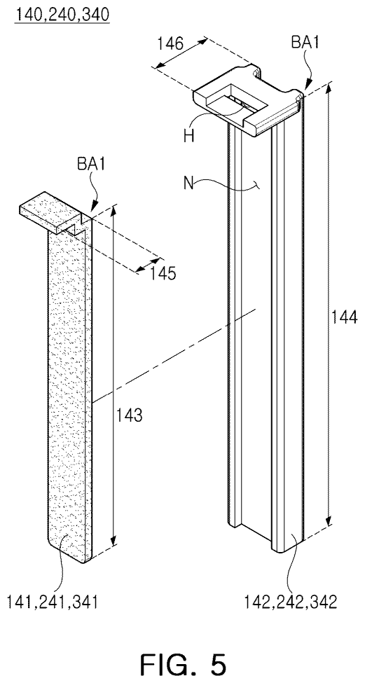

FIG. 5 is a schematic perspective view of a busbar assembly 140 based on an embodiment of the present disclosure.

The busbar assembly 140 illustrated in FIG. 5 may be a first busbar assembly 240 and a second busbar assembly 340.

As shown in FIG. 5, in an embodiment of the present disclosure, the busbar member 141 may include a first body region 143 including a contact region A1 and a first extension region 145 bent and extending from the first body region 143. Additionally, the insulating member 142 supporting the busbar member 141 may include a second body region 144 in contact with the first body region 143 and a second extension region 146 bent and extending from the second body region 144 and supporting the first extension region 145. Each of the busbar member 141 and the insulating member 142 may include a first bending region BA1.

In an embodiment, the busbar member 141 may include a first busbar member 241 and a second busbar member 341. Accordingly, the first busbar member 241 and the second busbar member 341 may include a first body region 143 and a first extension region 145, respectively.

Additionally, the insulating member 142 may include a first insulating member 242 and a second insulating member 342. Accordingly, the first insulating member 242 and the second insulating member 342 may include a second body region 144 and a second extension region 146, respectively.

However, for the convenience of understanding, the first busbar member 241 and the first insulating member 242 will be described as examples below, but the following description may also be applied to the second busbar member 341 and the second insulating member 342 in the same principle.

In an embodiment, the first insulating member 242 may include a coupling notch (N) into which at least a portion of the first busbar member 241 is inserted. The first busbar member 241 may be in contact with the coupling notch and may be fixed to the first busbar member 241. This may be applied to the second insulating member 342 and the second busbar member 341 in the same principle.

Additionally, as an example, a connecting passage H may be provided in the second extension region 146. The connecting passage H may be a passage through which the first extension region 145 of the first busbar member 241 is withdrawn. In some cases, the first busbar member 241 may include a plurality of first bending regions BA1. Accordingly, the first extension region 145 may be easily exposed to the outside of the second extension region 146.

In the first bus bar member 241, one surface thereof may be in contact with the electrode lead 120, and the other surface opposite to the one surface may be in contact with the first insulating member 242. The first body region 143 of the first bus bar member 241 may have a contact region A1 in contact with the electrode lead 120. The first body region 143 may include a straight portion extending in a height direction (Z-direction) of the battery cell 110. The straight portion may be parallel to the height direction (Z-direction) of the battery cell 110.

The first bus bar member 241 may include a first extension region 145 bent and extending from the first body region 143. The first extension region 145 may be bent in the width direction (Y-direction) of the battery cell 110 from the first body region 143. The first extension region 145 may extend in a direction oriented toward the battery cell 110.

In an embodiment, the first bus bar member 241 and the first insulating member 242 may be in the form of at least one of a bar and a plate. Here, at least a partial region of the bar or plate may be bent.

The first insulating member 242 may include a second body region 144 with which the first body region 143 is in contact. The second body region 144 may include a straight portion extending in the height direction (Z-direction) of the battery cell 110. The straight portion may be parallel to the height direction (Z-direction) of the battery cell 110. The first insulating member 242 may be a material having electrical insulation properties.

The first insulating member 242 may include a second extension region 146 bent and extending from the second body region 144. The second extension region 146 may be bent in the width direction (Y-direction) of the battery cell 110 from the second body region 144. The second extension region 146 may extend in a direction oriented toward the battery cell 110. The second extension region 146 may be bent and extend in the same direction as the first extension region 145.

The electrode lead 120 may be in contact with the first body region 143 and may not be in contact with the first extension region 145, the second body region 144, and the second extension region 146.

Additionally, the first extension region 145 and the second extension region 146 may not face the case 150. Specifically, the first extension region 145 and the second extension region 146 may not face a surface on which the case 150 faces the cathode lead 121 and the anode lead 122. Accordingly, electrical insulation between the busbar member 141 and the case 150 may be implemented. This may contribute to improving the safety and electrical stability of the battery apparatus 100 in use.

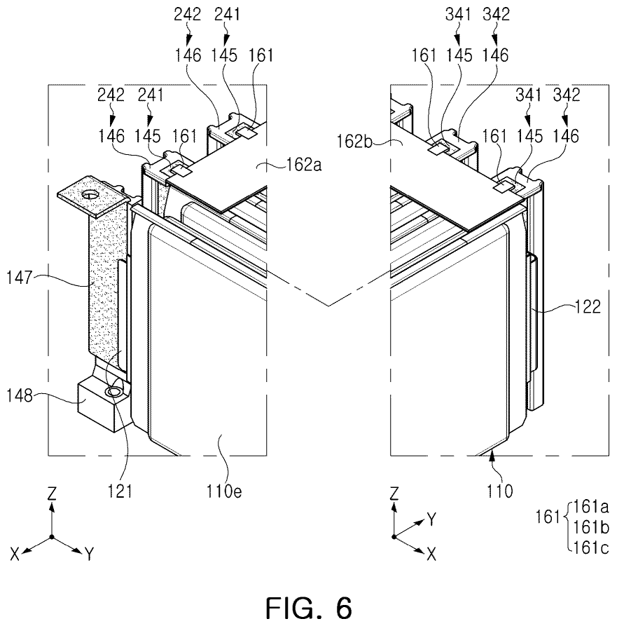

FIG. 6 is a perspective: view schematically illustrating an upper portion of a plurality of battery cells 110 and a busbar assembly 140 based on an embodiment of the present disclosure, and illustrates a connection state of the sensing assembly 160 and the busbar assembly 140.

As shown in FIG. 1, FIG. 5 and FIG. 6, the battery apparatus 100 according to an embodiment of the present disclosure may further include a sensing assembly 160 in contact with the first extension region 145.

The sensing assembly 160 may be disposed in an upper portion of the plurality of battery cells 110, more specifically, in an upper portion of the plurality of battery cells 110 in the height direction (Z-direction or +Z-direction). The sensing assembly 160 may be connected to the first bus bar assembly 240 and the second bus bar assembly 340.

In an embodiment, the sensing assembly 160 may include a sensing terminal 161 in contact with the first extension region 145 and at least one substrate 162 connected to the sensing terminal 161 and disposed so that at least a partial region thereof faces a side sealing portion 115 of the plurality of battery cells 110. The at least one substrate may include a first substrate 162a and a second substrate 162b.

Additionally, as an example, the sensing assembly 160 may include at least one of a temperature sensor, a voltage measurement sensor or a current measurement sensor, which is connected to the sensing terminal 161 and the first substrate 162a. The temperature sensor may be in contact with at least a partial region of the battery cell 110 to measure the temperature of the battery cell 110. The voltage measurement sensor and the current measurement sensor may measure voltage and a current of the battery cell 110 through the busbar member 141. Temperature, voltage and current measurement information may be provided to a controller (e.g., BMS) through the first substrate 162a.

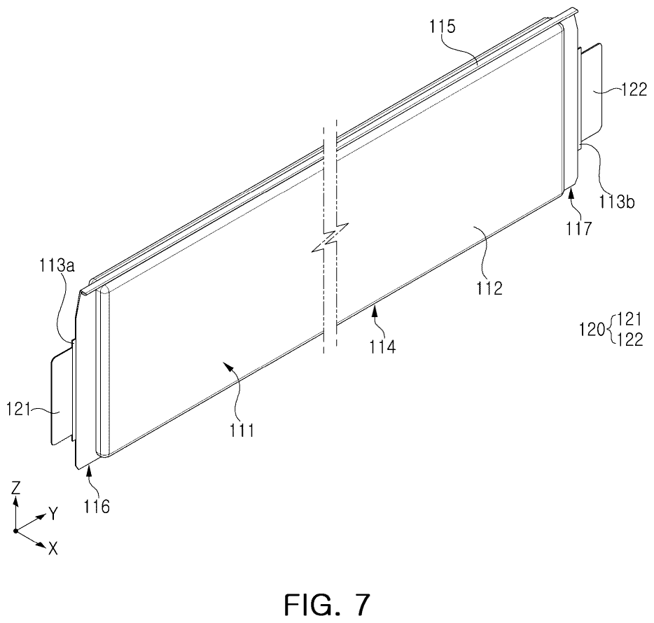

Meanwhile, FIG. 7 is a schematic perspective view of a battery cell 110 based on an embodiment of the present disclosure. Referring to FIG. 7, when the battery cell 110 according to an embodiment of the present disclosure is described, the battery cell 110 according to an embodiment of the present disclosure may be a bidirectional battery cell 110 as described above.

The battery cell 110 may have a form in which a cathode plate, an anode plate, a separator, and an electrolyte exist inside an outer material 111. The cathode plate and the anode plate are isolated from each other by the separator, and an electrode assembly may be comprised of the cathode plate, the anode plate, and the separator. The electrode assembly may be accommodated in the outer material 111, and the outer material 111 may include an electrode assembly accommodation space 112 for accommodating the electrode assembly. The electrode assembly accommodation space 112 may be formed by an inner surface of the outer material 111.

The outer material 111 may be in the form of a film in which PET (polyethylene terephthalate, PET), nylon, and aluminum are stacked.

In an embodiment, the outer material 111 may be a single film or a single sheet. The battery cell 110 may be formed by folding the outer material 111 so that both ends of the outer material 111 are in contact with each other, and thermally fusing and sealing an overlapping region in a state in which the remaining three edges, except for an edge at which a folding line is formed, overlap each other.

Thereamong, the two sealing portions may be a first sealing portion 116 and the second sealing portion 117. The first sealing portion 116 and the second sealing portion 117 may face the cathode lead 121 and the anode lead 122. The remaining one sealing portion that does not face the cathode lead 121 and the anode lead 122 may be folded in a direction oriented toward the electrode assembly accommodation space 112 of the battery cell 110 and may be fixed to the outer material 111. Here, the remaining one sealing portion may be a side sealing portion 115.

Among the remaining two sealing portions of the outer material 111 excluding the side sealing portion 115, one sealing portion may be disposed adjacently to the cathode lead 121, and the other sealing portion may be disposed adjacently to the anode lead 122.

The outer material 111 may be sealed in a state in which the cathode lead 121 and the anode lead 122 are exposed to the outside of the outer material 111.

In an embodiment, a first lead film 113a may be provided between the cathode lead 121 and the outer material 111, and a second lead film 113b may be provided between the anode lead 122 and the outer material 111. The first lead film 113a and the second lead film may be electrically insulating materials. Accordingly, the outer material 111 and the cathode lead 121 may be electrically insulated, and the outer material 111 and the anode lead 122 may be electrically insulated.

A surface or an edge of the outer material 111 of the battery cell 110 in which there is no sealing portion may be a bottom surface 114 of the battery cell 110. The bottom surface 114 of the battery cell 110 may be spaced apart from a side sealing portion 115 in the height direction (Z-direction) of the battery cell 110 and may face the side sealing portion 115.

The battery cell 110 may be accommodated in the case 150 so that the bottom surface 114 contacts or faces the case 150. In some cases, a heat transfer material may be further provided between the bottom surface 114 of the battery cell 110 and the case 150.

As shown in FIGS. 1, 5, 6 and 7, a plurality of battery cells 110 may be stacked so that the side sealing portions 115 are disposed to be parallel to each other.

Additionally, the sensing terminal 161 may be formed of a material having electrical insulation and may be connected to the first extension region 145. The sensing terminal 161 may be connected to the first extension region 145 through welding, an adhesive, a tape, or the like.

Accordingly, a connection region of the sensing terminal 161 and the first extension region 145 may not also face a side surface of the case 150. The second body region 144 and the second extension region 146 of the insulating member 142 may electrically insulate a connection region of the sensing terminal 161 and the first extension region 145 from the case 150.

In some cases, the sensing terminal 161 may be provided in plural, and the sensing terminal 161 may also be connected to the first bus bar member 241 and the second bus bar member 341. The sensing terminal 161 may be connected to the first extension region 145 of the first bus bar member 241 and the first extension region 145 of the second bus bar member 341, respectively.

Additionally, the contact region A1 of the sensing terminal 161 and the bus bar member 141 may be disposed in the first extension region 145. Accordingly, the contact region A1 of the sensing terminal 161 and the bus bar member 141 may not face the side surface of the case 150 and may be electrically insulated from the side surface of the case 150. Here, the side surface of the case 150 may be a surface facing or parallel to at least one of one side surface 118 and the other side surface 119 of the plurality of battery cells 110 in the case 150. Additionally, the side surface of the case 150 may be provided in plural. In this case, a plurality of side surfaces of the case 150 may face or may be parallel to one side surface 118 and the other side surface 119 of the plurality of battery cells 110.

The sensing terminal 161 may be connected to the substrate 162, and the substrate 162 may be a printed circuit board (PCB).

In an embodiment, the substrate 162 may be provided in plural. The plurality of substrates 162 may include a first substrate 162a connected to a first bus bar member 241 disposed on one side surface 118 of the plurality of battery cells 110, and a second substrate 162b connected to a second bus bar member 341 disposed on the other side surface 119 of the plurality of battery cells 110.

The first substrate 162a and the second substrate 162b may be connected to the first bus bar member 241 and the second bus bar member 341 by a plurality of sensing terminals 161.

Additionally, as an example, the first substrate 162a and the second substrate 162b may be connected by a connection board 162c. The connection board 162c may be a flexible printed circuit board (FPCB). However, this is not necessarily limited by the present disclosure.

The sensing assembly 160 may sense a temperature, voltage information, and the like, of the plurality of battery cells 110. The sensing assembly 160 may be connected to a Battery Management System (BMS). The sensing assembly 160 may transmit the sensed information to the BMS.

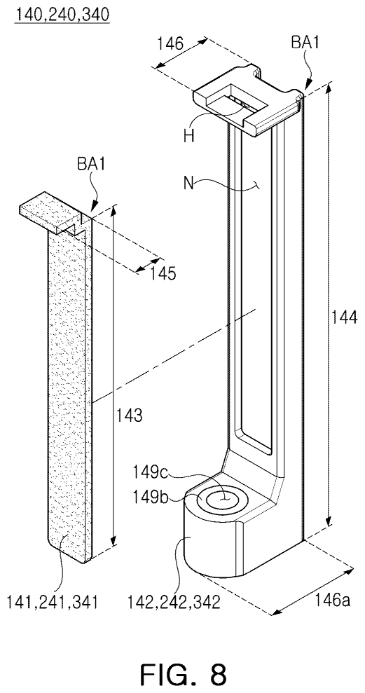

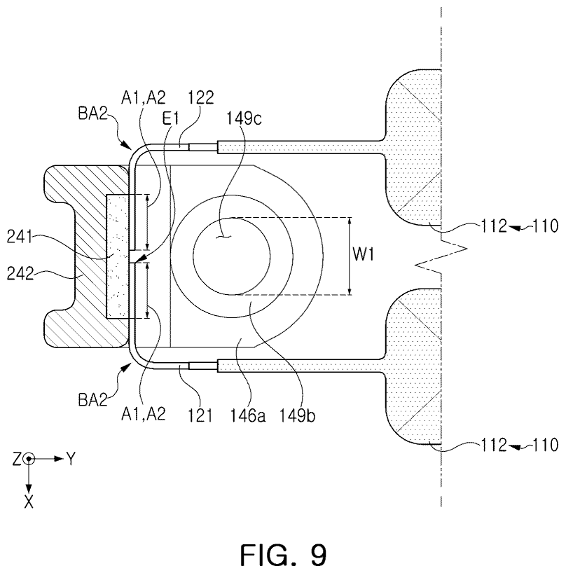

FIG. 8 is a schematic exploded perspective view of an insulating member 142 based on another embodiment of the present disclosure. The insulating member 142 illustrated in FIG. 8 may be a first insulating member 242 and a second insulating member 342. Additionally, FIG. 9 is a plan view schematically illustrating a state in which the insulating member 142 illustrated in FIG. 8 is connected to a battery cell 110. In FIG. 9, a portion of the insulating member 142 is illustrated in a cross-section, and the second extension region 146 is omitted in FIG. 9.

As shown in FIGS. 1, 4, 8, and 9, in another embodiment of the present disclosure, the insulating member 142 may further include a third extension region 146a bent and extending from the second body region 144, and spaced apart from the second extension region 146 to face the second extension region 146.

The insulating member 142 may have a ‘⊏,’ or ‘[’ shape in the cross-section in the height direction (Z-direction) of the battery cell 110. The third extension region 146a may be spaced apart from the second extension region 146, and the second extension region 146 and the third extension region 146a may be connected by the second body region 144.

The second extension region 146 may be disposed in a direction oriented upwardly in the +Z-direction of the battery cell 110, and the third extension region 146a may be disposed in a direction oriented downwardly in the −Z-direction of the battery cell 110. The third extension region 146a may not face the case 150.

The third extension region 146a may be connected to a lower region in the height direction (Z-direction or −Z-direction) of the battery cell 110 of the case 150. Accordingly, the insulating member 142 may be fixed to the case 150.

The second extension region 146 and the third extension region 146a may be disposed to intersect or be perpendicular to the second body region 144 and may be non-faced to the side surface of the case 150.

Additionally, in an embodiment, the end E1 of the cathode lead 121 may be bent, and the cathode lead 121 may include a second bending region BA2. The anode lead 122 may also include the second bending region BA2 in the same principle. According thereto, a region in contact with the bus bar member 141 may be easily formed in the electrode lead 120.

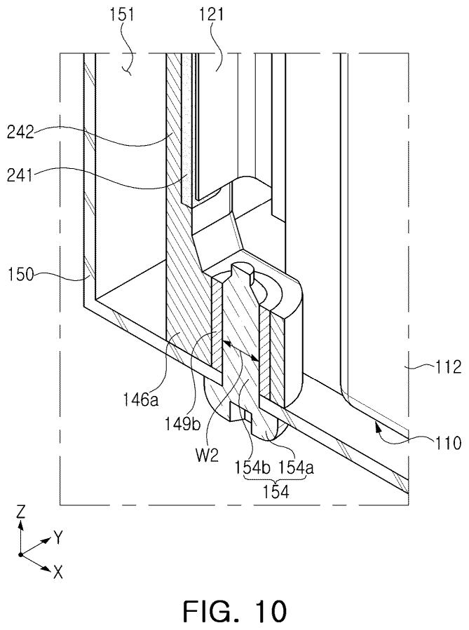

FIG. 10 is a cross-sectional view schematically illustrating a state in which the insulating member 142 illustrated in FIG. 8 is fixed to the case 150. The insulating member 142 illustrated in FIG. 10 may be a first insulating member 242 and a second insulating member 342.

The battery apparatus 100 according to an embodiment of the present disclosure may further include a fastening member 154 connecting the third extension region 146a and the case 150.

The fastening member 154 may penetrate through the third extension region 146a and may be fixed to the case 150.

The second extension region 146 and the third extension region 146a may be disposed to intersect or be perpendicular to the second body region 144 and may not face the side surface of the case 150.

Additionally, in an embodiment, the insulating member 142 may further include a through-hole 149a formed in the third extension region 146a and an insulating ring 149b inserted into the through-hole 149a and including a hollow portion 149c. In this case, the insulating member 142 may be a first insulating member 242 and a second insulating member 342. Accordingly, the first insulating member 242 and the second insulating member 342 may include the through-hole 149a and the hollow portion 149c, respectively.

Although only one insulating member 142 is illustrated in FIG. 10, a plurality of insulating members 142, a plurality of first insulating members 242 and a plurality of second insulating members 342 may be fixed to the case 150 in the same principle as illustrated in FIG. 10. For this purpose, the fastening member 154 may be provided in plural. The type of the fastening member 154 is not necessarily limited by the present disclosure, but as an example, the fastening member 154 may be a bolt.

The insulating ring 149b may be formed of a material having electrical insulation. A width W1 of the hollow portion 149c of the insulating ring 149b may be greater than or equal to a width W2 of the fastening member 154. The fastening member 154 may penetrate through the case 150 and may be inserted into the hollow portion 149c. Alternatively, the fastening member 154 may penetrate through the hollow portion 149c and may be fixed to the case 150.

For example, when the fastening member 154 is a bolt, a head 154a of the bolt may be in contact with the case 150, and a body 154b of the bolt may be inserted into the hollow portion 149c or may be inserted into the hollow portion 149c and may thus be exposed to the outside of the insulating ring 149b. In this case, the width W2 of the fastening member 154 may be identical to a width of the body portion 154b.

The fastening member 154 may be applied as a bolt, thereby securing the rigidity of the battery apparatus 100 by a certain level.

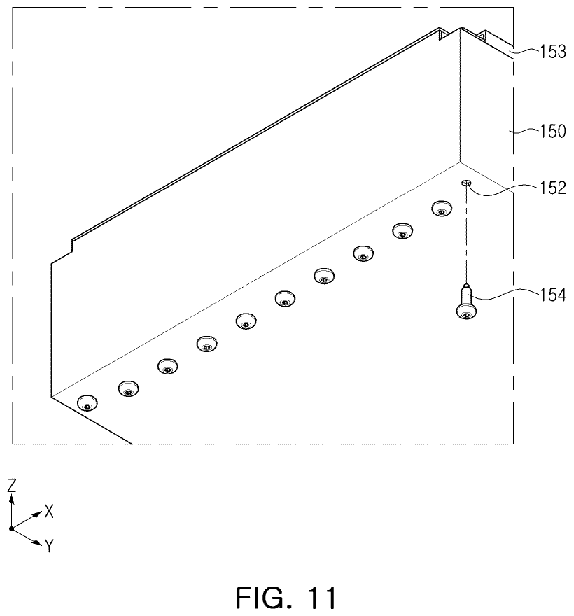

FIG. 11 schematically illustrates a bottom surface of the case 150 illustrated in FIG. 10. As shown in FIG. 10 and FIG. 11, the head of the fastening member 154 may be exposed to the outside of the case 150. The fastening member 154 may be inserted into the hollow portion 149c by penetrating through the case 150.

To this end, another fastening hole 152 corresponding to the through-hole 149a may be formed in the case 150.

In an embodiment, an inner surface of the insulating ring 149b may further be provided with a screw groove corresponding to a screw thread formed on an outer surface of the fastening member 154. Accordingly, the insulating member 142 may be more firmly fixed to the case 150. However, this is not necessarily limited by the present disclosure.

Additionally, in some cases, a nut may be fastened to the body portion 154b of the bolt to more firmly fix the fastening member 154.

The assembly efficiency of the battery apparatus 100 may be improved, and the space efficiency of the battery apparatus 100 may be improved. Additionally, electrical insulation performance may be improved in a portion of the battery apparatus 100 that requires insulation. Additionally, a weight of the battery apparatus 100 may be reduced by removing unnecessary parts from the battery apparatus 100. Additionally, the contact strength between the electrode lead 120 and the bus bar member 141 in the battery apparatus 100 may be increased, and the connection reliability between the electrode lead 120 and the bus bar member 141 may be improved.

Meanwhile, as shown in FIG. 1 and FIG. 11, a cover member 153 may be further provided on an upper portion of the battery cell 110 of the case 150 in the height direction (Z-direction or +Z-direction). The cover member 153 may cover upper portions of the plurality of battery cells 110.

In an embodiment, the cover member 153 may cover the sensing assembly 160 and the upper portions of the plurality of battery cells 110. According thereto, the plurality of battery cells 110 and the sensing assembly 160 may be protected from the external environment.

Additionally, the cover member 153 may prevent flames, sparks, or the like, from being transmitted or transferred to the outside of the battery apparatus 100 when thermal runaway occurs due to the battery cell 110.

In some cases, a venting path for venting gas may be formed in the cover member 153. The venting path may be, for example, a hole penetrating through the cover member 153.

In an embodiment, the cover member 153 may be bonded or welded to the case 150.

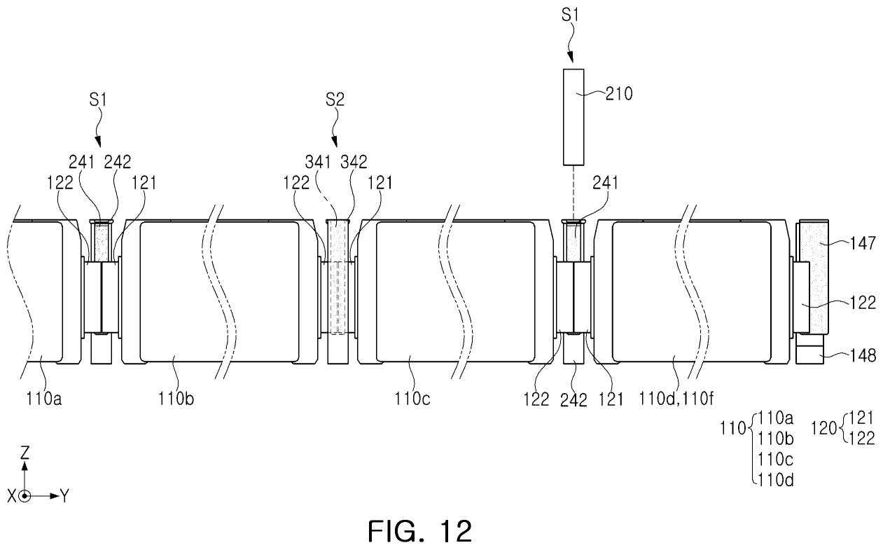

Additionally, as shown in FIG. 1 and FIG. 12, in an embodiment of the present disclosure, the busbar assembly 140 may further include an outer busbar member 147 in contact with an electrode lead 120 of a first outermost battery cell 110e, which is a battery cell 110 disposed in an outermost portion of one side, among the plurality of battery cells 110, and an electrode lead 120 of a second outermost battery cell 110f, which is a battery cell 110 disposed in an outermost portion of the other side, and a side insulating member 148 supporting the outer busbar member 147.

For example, the outer busbar member 147 and the side insulating member 148 may be provided in plural. Among the plurality of outer busbar members 147, one outer busbar member 147 may be connected to the electrode lead 120 of the first outermost battery cell 110e disposed in the outermost portion of one side, among the plurality of battery cells 110, and another outer busbar member 147 may be connected to the electrode lead 120 of the second outermost battery cell 110f disposed in the outermost portion of the other side, among the plurality of battery cells 110.

In an embodiment, one outer busbar member 147 may be connected to the cathode lead 121 of the first outermost battery cell 110e, and another outer busbar member 147 may be connected to the anode lead 122 of the second outermost battery cell 110f.

In this case, the second outermost battery cell 110f may be disposed so that the electrode lead 120 is misaligned with the first outermost battery cell 110e in the thickness direction of the battery cell 110. That is, the anode lead 122 of the second outermost battery cell 110f may be positioned on one side surface 118 of the plurality of battery cells 110, and the cathode lead 121 of the second outermost battery cell 110f may be disposed on the other side surface 119 of the plurality of battery cells 110.

That is, the cathode lead 121 of the first outermost battery cell 110e may be disposed to be parallel to the anode lead 122 of the second outermost battery cell 110f in the X-axis direction. However, this is not necessarily limited by the present disclosure, and may be determined by whether the plurality of battery cells 110 are connected in series and/or in parallel. Additionally, whether the plurality of battery cells 110 are connected in series, connected in parallel, and used in series and parallel is not necessarily limited by the present disclosure.

Additionally, as shown in FIG. 1 and FIG. 4, in a pair of battery cells 110 facing each other or adjacent to each other in the X-axis direction, the cathode lead 121 of one battery cell 110 may not be connected to the cathode lead 121 or the anode lead 122 of the other battery cell 110. Additionally, in the pair of battery cells 110 facing each other or adjacent to each other, the anode lead 122 of the one battery cell 110 may not be connected to the cathode lead 121 or the anode lead 122 of the other battery cell 110.

That is, in the pair of battery cells 110 adjacent to each other in the thickness direction of the battery cells 110, the pair of battery cells 110 may be provided so that only one pair of electrode leads 120 may be connected to each other. In this case, the pair of electrode leads 120 may both be cathode leads 121 or both may be anode leads 122, and may be electrode leads 120 having different electrical polarities. That is, the pair of electrode leads 120 may be cathode leads 121 and anode leads 122. In this manner, depending on whether the plurality of battery cells 110 are connected in series or in parallel, at least some of the electrode leads 120, among the plurality of electrode leads 120 of the pair of battery cells 110 adjacent to each other, may not be connected to each other.

In an embodiment of the present disclosure, the side insulating members 148 may be provided in plural. The plurality of side insulating members 148 may be respectively connected to the plurality of outer bus bar members 147. The plurality of side insulating members 148 may support the plurality of outer bus bar members 147.

The side insulating member 148 may be provided with a material having electrical insulation properties. For example, the side insulating member 148 may be formed of the same material as the first insulating member 242 and the second insulating member 342.

As shown in FIG. 1 and FIG. 2, the outer bus bar member 147 may be disposed to face the case 150 or to be spaced apart from the case 150.

At least a portion of the outer bus bar member 147 may be exposed to the outside of the case 150. In some cases, a plurality of battery apparatuses 100 may be electrically connected to each other by electrically connecting each of the outer bus bar members 147 to each other. In some cases, a separate electrically conductive material may be provided to connect the outer bus bar members 147 of the plurality of battery apparatuses 100 to each other.

As described above, the outer bus bar member 147 may enable electrical connection between the plurality of battery apparatuses 100. In some cases, the outer bus bar member 147 may enable an energy storage device to be constructed by collecting the plurality of battery apparatuses 100 and may construct a battery apparatus 100 capable of a large output.

Meanwhile, the present disclosure as another aspect provides a manufacturing apparatus of a battery apparatus 100. The battery apparatus 100 may be the battery apparatus 100 described above.

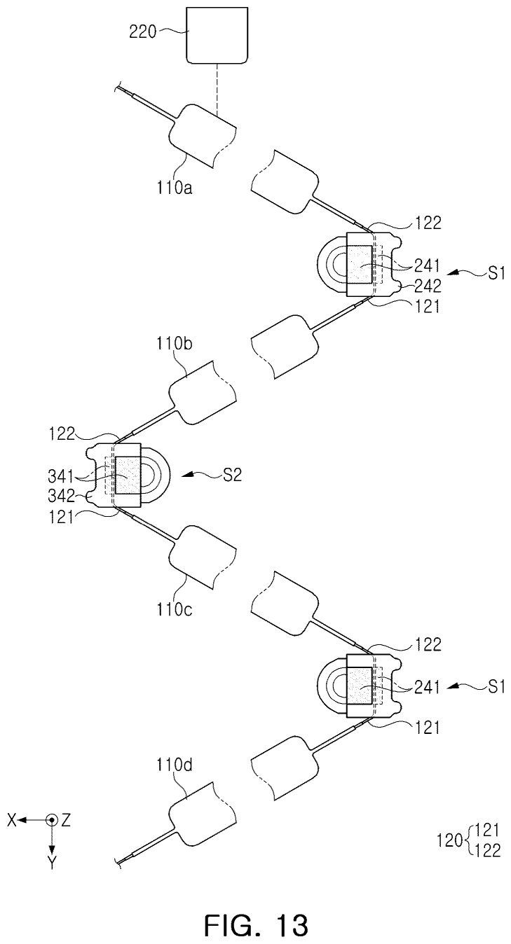

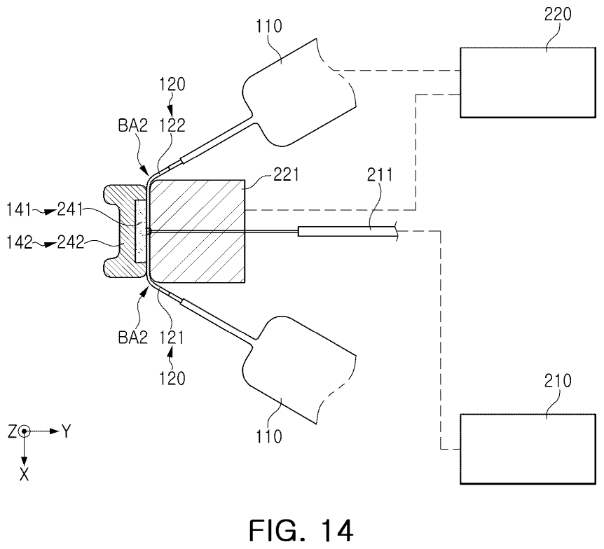

FIG. 12 schematically illustrates a portion of a battery apparatus 100 welded by a welding device 210 of a manufacturing apparatus of a battery apparatus 100 based on an embodiment of the present disclosure, FIG. 13 schematically illustrates a portion of a battery apparatus 100 folded by a folding device 220 of a manufacturing apparatus of a battery apparatus 100 based on an embodiment of the present disclosure. An X-axis, a Y-axis and a Z-axis in FIG. 13 are illustrated based on positions of the first bus bar member 241, the first insulating member 242, the second bus bar member 341, the electrode leads 121 and 122, and the second insulating member 342 in FIG. 12. Accordingly, in FIG. 13, the X-axis, the Y-axis and the Z-axis of battery cells 110a, 110b, 110c and 110d should be understood as an X-axis, a Y-axis and a Z-axis in a position before folding the electrode leads 121 and 122. Meanwhile, FIG. 14 schematically illustrates a manufacturing process of a manufacturing apparatus of the battery apparatus 100.

As shown in FIGS. 12 to 14, the manufacturing apparatus of a battery apparatus 100 according to an embodiment of the present disclosure may include a welding device 210 welding an electrode lead 120 of one battery cell 110, among a plurality of battery cells 110, and an electrode lead 120 of the other battery cell 110 to a busbar member 141, and a jig member 221 disposed to face the electrode lead 120 of the one battery cell 110 and the electrode lead 120 of the other battery cell 110, and may further include a folding device 220 moving at least one of the one battery cell 110 and the other battery cell 110.

First, referring to FIG. 12, the manufacturing apparatus of the battery apparatus 100 may perform welding for connecting the electrode leads 120 of each of the plurality of battery cells 110 after arranging or lining up a plurality of battery cells 110. The welding may be performed by the welding device 210.

The welding device 210 may electrically connect the electrode leads 120 of the plurality of battery cells 110 to each other. In this case, the plurality of battery cells 110 may be connected in series or in parallel, but this is not necessarily limited by the present disclosure.

In an embodiment, the welding device 210 may weld the anode lead 122 of the first battery cell 110a to the first bus bar member 241. Additionally, the cathode lead 121 of the second battery cell 110b adjacent to the first battery cell 110a may be welded to the first bus bar member 241. However, the type of the electrode lead 120 is only one example of the present disclosure, and may be changed depending on whether the electrode leads 120 are connected in series or in parallel. In some cases, the anode lead 122 of the second battery cell 110b may be connected to the cathode lead 121 of the first battery cell 110a. Alternatively, the cathode lead 121 of the first battery cell 110a may be connected to the cathode lead 121 of the second battery cell 110b, and the anode lead 122 of the first battery cell 110a may be connected to the anode lead 122 of the second battery cell 110b.

As shown in FIG. 12, when the cathode lead 121 of the second battery cell 110b is welded to the anode lead 122 of the first battery cell 110a, the welding device 210 may weld the anode lead 122 of the second battery cell 110b to the second bus bar member 341, and may weld the cathode lead 121 of the third battery cell 110c adjacent to the second battery cell 110b to the second bus bar member 341.

Additionally, the welding device 210 may weld the anode lead 122 of the third battery cell 110c to another first bus bar member 241, and may weld the cathode lead 121 of the fourth battery cell 110d adjacent to the third battery cell 110c to another first bus bar member 241. In this principle, a plurality of battery cells 110 may be arranged or lined up in a row, and the plurality of battery cells 110 may be electrically connected. In this case, the welding device 210 may weld the electrode lead 120 of the battery cell 110 disposed in an outermost portion to the outer bus bar member 147.

The plurality of battery cells 110 that have been welded may be arranged or lined up in a row in the width direction (Y-direction) of the battery cell 110. In an embodiment, the welding device 210 may weld the electrode leads 120 of the battery cells 110 in a state in which the plurality of battery cells 110 are arranged or lined up in the width direction (Y-direction) of the battery cells 110.

The plurality of battery cells 110 that have been welded may have the cathode lead 121, the anode lead 122, and the first bus bar member 241 disposed in the first direction in a first welding position S1, and may have the anode lead 122, the cathode lead 121 and the second bus bar member 341 disposed in a second direction in a second welding position S2.

The first welding position S1 and the second welding position S2 may be alternately disposed in a width direction (Y-direction) of the battery cells 110 or in a direction in which the plurality of battery cells 110 are arranged. For example, the second welding location S2 may be interposed between the pair of first welding locations S1 of the battery cell 110 in the width direction (Y-direction).

As shown in FIG. 12 and FIG. 13, the first welding position S1 may be provided so that the plurality of electrode leads 120 may be disposed on an upper surface in the +X-direction more than the first bus bar member 241, and the second welding position S2 may be provided so that the plurality of electrode leads may be disposed to be lower in the −X-direction than the second bus bar member 341. The first welding position S1 may provide a welding heat source to the plurality of electrode leads 120 in a state in which the plurality of electrode leads 120 are disposed above the first bus bar member 241. The second welding position S2 may also provide a welding heat source to the plurality of electrode leads 120 in a state in which the plurality of electrode leads 120 are disposed above the second bus bar member 341. In the first welding position S1, the welding head may provide a heat source in the −X-direction in a state of facing the plurality of electrode leads 120, and in the second welding position S2, the welding head may provide a heat source in the +X-direction in a state of facing the plurality of electrode leads 120. For example, the welding head may be a laser welding head.

Additionally, the first direction described above may be a direction in which the plurality of electrode leads 120 and at least a partial region of the first bus bar member 241 are visible from the front at a viewpoint of FIG. 12, in a state in which the plurality of battery cells 110 are arranged or lined up in the width direction (Y-direction) of the battery cells 110.

The second direction may be a direction in which the plurality of electrode leads 120 and at least a partial region of the second bus bar member 341 are not visible from the front at the viewpoint of FIG. 12, in a state in which the plurality of battery cells 110 are arranged or lined up in the width direction (Y-direction) of the battery cells 110. That is, in the second direction, at least a partial region of the second insulating member 342 may be viewed from the front at the viewpoint of FIG. 12.

For example, in the second welding position S2, among the second bus bar member 341, the second insulating member 342 and the pair of electrode leads 120, the second insulating member 342 may be disposed in an uppermost portion in the +X-direction, the second bus bar member 341 may be disposed in the −X-direction with respect to the second insulating member 342, and the pair of electrode leads 120 may be disposed in the −X-direction with respect to the second bus bar member 341.

In the first welding position S1, among the first busbar member 241, the first insulating member 242 and the pair of electrode leads 120, one pair of electrode leads 120 may be disposed in the uppermost portion in the +X-direction, the first busbar member 241 may be disposed in the −X-direction with respect to the pair of electrode leads 120, and the first insulating member 242 may be disposed in the −X-direction with respect to the first busbar member 241. In this case, the above-described positional relationships may be positional relationships in a region in which the first busbar member 241 and the pair of electrode leads 120 are in contact with each other, and in a region in which the second busbar member 341 and the pair of electrode leads 120 are in contact with each other.

According thereto, the electrode leads 120 of the plurality of battery cells 110 that is folded (or has been folded) by the folding device 220 may be disposed in a direction oriented the toward electrode assembly accommodation space 112 of the battery cell 110, and the electrode leads 120 of the plurality of battery cells 110 may face the electrode assembly accommodation space 112 of the battery cell 110 or a side surface of the battery cell 110.

Accordingly, the electrode leads 120 (or the plurality of battery cells 110) may be folded to complete a stacking or laminating operation of the plurality of battery cells 110. This may contribute to improving the assembly efficiency of the battery apparatus 100.

Meanwhile, as shown in FIG. 14, the welding device 210 may include a welding head 211 welding the electrode leads 120 to the busbar member 141. The welding device 210 may be a laser welding device 210. The welding device 210 may perform a lab welding of the electrode lead 120 to the busbar member 141. By utilizing the lab welding instead of T welding, the welding quality may be improved. However, the welding may be replaced with other welding besides laser welding.

In the plurality of battery cells 110 that have been welded and arranged in a row, the contact region A1 of the first busbar member 241 and the pair of electrode leads 120 may be disposed to be misaligned with the contact region A1 of the second busbar member 341 and the pair of electrode leads 120 in a line-up direction or an arrangement direction of the plurality of battery cells 110.

In other words, the contact region A1 of the first bus bar member 241 and the pair of electrode leads 120 may be disposed on the same plane as one surface of the battery cell 110, and the contact region A1 of the second bus bar member 341 and the pair of electrode leads 120 may be disposed on the same plane as the other surface of the battery cell 110. Here, the other surface of the battery cell 110 may face one surface of the battery cell 110 in the thickness direction of the battery cell 110.

Accordingly, in FIG. 12, at a point in time when a contact region of the first bus bar member 241 and the pair of electrode leads 120 is visually exposed to the front, the contact region of the second bus bar member 341 and the pair of electrode leads 120 may be covered by the second insulating member 342 and may not be visually confirmed.

In this manner, the contact region of the first bus bar member 241 and the pair of electrode leads 120 may be disposed to be misaligned with the contact region of the second bus bar member and the pair of electrode leads 120 in a line-up direction of the plurality of battery cells 110 or in the width direction (Y-direction) of the battery cell 110. Here, the width direction of the battery cell 110 may be a direction that is parallel to a straight line connecting the cathode lead 121 to the anode lead 122 based on one battery cell 110.

In an embodiment, the outer bus bar member 147 may be connected to one electrode lead 120 of the battery cell 110 disposed in an outermost portion in the width direction of the battery cell 110. For example, the anode lead 122 of the fourth battery cell 110d may be in contact with the outer bus bar member 147, and the welding device 210 may weld, for example, the anode lead 122 of the fourth battery cell 110d to the outer bus bar member 147.

In an embodiment, the folding device 220 may move at least one of the one battery cell 110 and the other battery cell 110 so that the electrode lead 120 of one battery cell 110 and the electrode lead 120 of the other battery cell 110 are in contact with the jig member 221.

As shown in FIGS. 12 and 13, the folding device 220 may fold the plurality of battery cells 110 by moving at least one battery cell 110, among the plurality of battery cells 110, after the welding of the welding device 210 is completed.

The folding device 220 may fold or bend the cathode lead 121 and the anode lead 122 by moving at least one battery cell 110. Accordingly, the electrode lead 120 of the battery cell 110 may be folded or bent in a state in which the electrode lead 120 has been welded to the busbar member 141.

As shown in FIG. 13, during a folding process of the plurality of battery cells 110 by the folding device 220, the plurality of battery cells 110 may be arranged in a zigzag shape. That is, during the welding process by the welding device 210, the plurality of battery cells 110 may be arranged in a row, and after the welding is completed, during the folding process by the folding device 220, the plurality of battery cells 110 may be arranged in a zigzag shape.

After the plurality of battery cells 110 are arranged in a zigzag shape, the plurality of battery cells 110 may be zigzag-folded (or Z-folded) by the folding device 220 so that the electrode assembly accommodation spaces 112 of the battery cells 110 adjacent to each other may face or contact each other. The plurality of electrode leads 120 of the plurality of battery cells 110 that have been folded may also be folded or bent. The plurality of battery cells 110 that have been zigzag-folded may be modularized and may be stored in a case 150 in this state. Accordingly, a connection operation between the electrode lead 120 of the battery cell 110 and the bus bar assembly 140 may be completed. Accordingly, the manufacturing efficiency or assembly efficiency of the battery apparatus 100 may be improved.

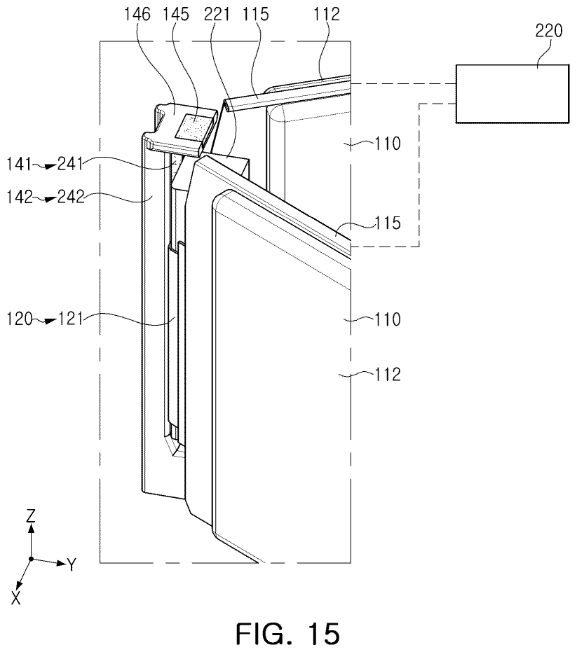

FIG. 14 is a plan view schematically illustrating a state in which a welding device 210 according to an embodiment of the present disclosure welds a plurality of electrode leads 120 and a state in which a folding device 220 moves a plurality of battery cells 110 to fold the plurality of electrode leads 120, and FIG. 15 is an operational state diagram schematically illustrating a state in which the folding device 220 according to an embodiment of the present disclosure moves the plurality of battery cells 110 to fold the plurality of electrode leads 120.

As shown in FIGS. 14 and 15, in an embodiment of the present disclosure, the folding device 220 may move at least one battery cell 110, among a pair of battery cells 110, so that a pair of battery cells 110 adjacent to each other are adjacent to each other after the welding device 210 completes welding the electrode lead 120 to the busbar member 141.

For example, the folding device 220 may move the battery cell 110 in a state in which a jig member 221 is in contact with the pair of electrode leads 120. Accordingly, a second bending area BA2 may be formed in the pair of electrode leads 120. The second bending area BA2 may be a folding region or a bending region of the pair of electrode leads 120, and the pair of electrode leads 120 may be a cathode lead 121 and an anode lead 122.

Meanwhile, the jig member 221 may be formed of a material having electrical insulation properties, and may be formed of a material having a certain level of rigidity or higher.

The folding device 220 may pressurize the pair of electrode leads 120 with a jig member 221 in a state in which the pair of electrode leads 120 is in contact with one bus bar member 141. The jig member 221 may pressurize the pair of electrode leads 120 toward the bus bar member 141. In this state, the folding device 220 may move at least one battery cell 110, or may move the plurality of battery cells 110 to fold or bend the electrode leads 120 along a surface of the jig member 221.

In an embodiment, a shape of a thickness direction cross-section of the battery cell 110 of the jig member 221 may be a square.

A folding line or a bending line of the plurality of electrode leads 120 may have a shape corresponding to an edge of the jig member 221. The folding line or the bending line may be a straight line that is parallel to the height direction (Z-direction) of the battery cell 110. The jig member 221 may be disposed so that a plurality of edges in contact with the plurality of electrode leads 120 are parallel to the height direction (Z-direction) of the battery cell 110.

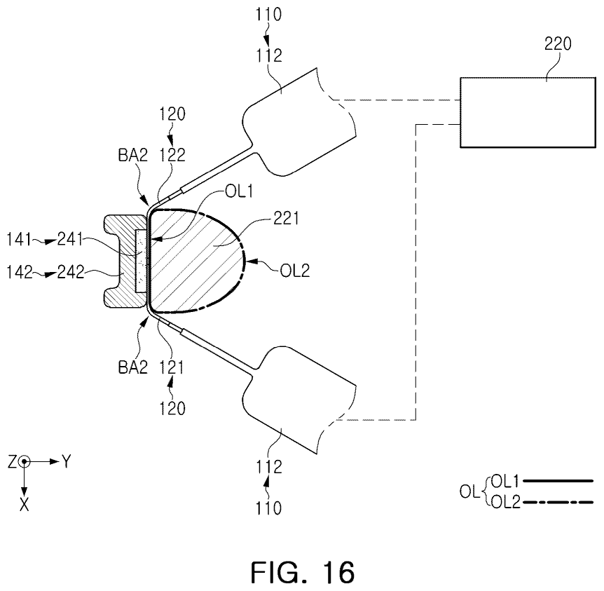

FIG. 16 schematically illustrates a state in which a folding device 220 according to another embodiment of the present disclosure moves a plurality of battery cells 110 to fold the plurality of electrode leads 120.

As shown in FIG. 16, in another embodiment of the present disclosure, the jig member 221 may include an outer line OL of a straight line and a curve in a cross-section of the battery cell 110 in the thickness direction.

Additionally, in an embodiment, a width of the jig member 221 in the thickness direction (X-direction) of the battery cell 110 may be widest on a surface in contact with the electrode lead 120, and may decrease in a direction away from the electrode lead 120. In this case, the electrode lead 120 may be a plurality of electrode leads 120, and a width of the battery cell 110 in the thickness direction (X-direction) may be a thickness direction of the battery cell 110 in a state in which the plurality of battery cells 110 have been stacked.

The width of the jig member 221 may be narrowest on a surface disposed closest to the battery cell 110 in a width direction (Y-direction) of the battery cell 110. The width of the jig member 221 may be narrowest on a surface disposed farthest from the battery cell 110 in a width direction (Y-direction).

In a cross-section of the battery cell 110 in the thickness direction (X-direction), a surface on which the jig member 221 is contact in which the plurality of electrode leads 120 may be a straight line. In the cross-section of the battery cell 110 in the thickness direction, an outer line of the jig member 221 may be provided so that a region in contact with the plurality of electrode leads 120 may be a straight line. In the cross-section of the battery cell 110 in the thickness direction, the outer line OL of the jig member 221 may be provided so that a region excluding the straight line may be a curve. For example, the outer line OL of the jig member 221 may include a first outer line OL1 that is a straight line, and a second outer line OL2 that is connected to the first outer line OL1 and is a curve.

According to the shape of the jig member 221, not only may a plurality of electrode leads 120 be easily bent, but also, when a pair of battery cells 110 are moved or folded in a direction that brings the battery cells 110 closer to each other, the jig member 221 may be prevented from interfering with the pair of battery cells 110.

Accordingly, the efficiency of a battery manufacturing operation may be improved, and the quality of the battery apparatus 100 may be improved.

Additionally, when the plurality of electrode leads 120 are bent or folded in the state in which the plurality of electrode leads 120 are pressurized by the jig member 221, the contact reliability and connection reliability between the plurality of electrode leads 120 and the busbar member 141 may be improved.

In an embodiment, the welding device 210 may be a laser welding device 210 including a welding head 211, and the folding device 220 may be formed by applying a robot arm, a machining center, various devices utilizing Computer Aided Engineering (CAE), or the like, alone or in combination. Additionally, the welding device 210 and the folding device 220 may be implemented as a combination of a cylinder, a linear motion structure, various gears, couplings, and the like.

The linear motion structure may include at least one of a linear bearing, a linear guide, a ball screw, a linear actuator, a linear motor or a linear slide.

For example, the welding device 210 may further include an actuator that may move the welding head 211 along a welding target region. The actuator may be driven by driving force of the motor. However, the type of the actuator is not necessarily limited by the present disclosure.

For example, the folding device 220 may include a robot arm that moves the other battery cell 110 while supporting one battery cell 110. In some cases, the robot arm may move a plurality of battery cells 110 in a direction that brings the battery cells 110 closer to each other.

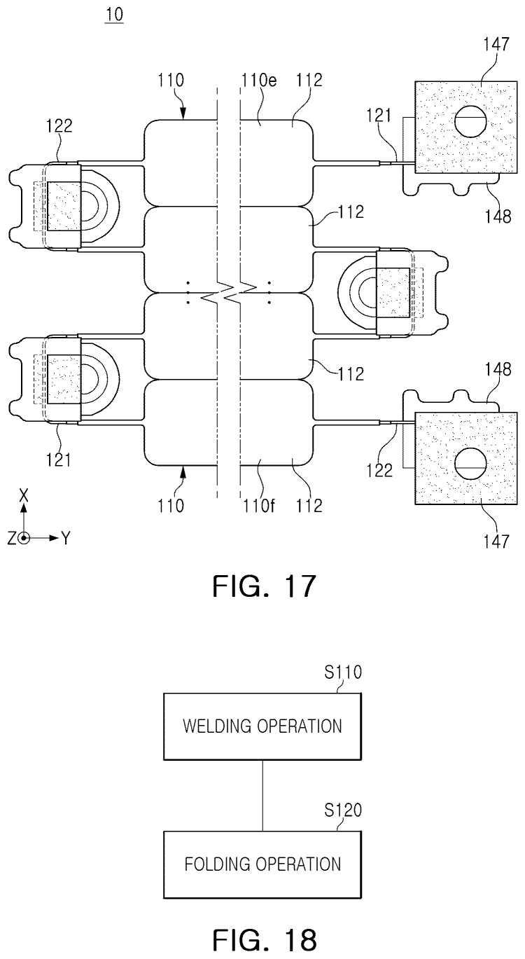

FIG. 17 schematically illustrates a battery cell assembly 10 manufactured by a manufacturing apparatus of a battery apparatus 100 based on another embodiment of the present disclosure. The battery cell assembly 10 may include a plurality of battery cells 110, a plurality of busbar members 141, and a plurality of insulating members 142. In FIG. 17, a greater number of battery cells 110 may be disposed in a middle portion (e.g., a middle portion in the X-direction) of the battery cell assembly 10.

As shown in FIG. 17, the manufacturing apparatus of the battery apparatus 100 may manufacture the battery cell 110 assembly 10 by folding a plurality of battery cells 110 or a plurality of electrode leads 120 by a folding device 220. The battery cell assembly 10 may be formed by stacking or laminating a plurality of battery cells in which busbar members 141 has been welded.

FIG. 17 illustrates an example in which the cathode lead 121 of the first outermost battery cell 110e is connected to the outer busbar member 147, and the anode lead 122 of the second outermost battery cell 110f is connected to the outer busbar member 147. However, the electrical polarity of the electrode lead 120 connected to the outer busbar member 147 is not necessarily limited by the present disclosure. Additionally, as an example, the outer busbar member 147 may be supported by the side insulating member 148.

However, the positions of the electrode leads 120 of the plurality of battery cells 110, the first outermost battery cell 110e and the second outermost battery cell 110f may be changed depending on whether the plurality of battery cells 110 are connected in series or in parallel.

As shown in FIG. 1 and FIG. 17, the battery cell 110 assembly 10 may be accommodated in the case 150 and manufactured as a battery apparatus 100.

The folding device 220 may zigzag-fold all of the plurality of battery cells 110 or the plurality of electrode leads 120 at once, or may zigzag-fold the plurality of battery cells 110 or the plurality of electrode leads 120 in stages over multiple times. However, this is not necessarily limited by the present disclosure. The folding device 220 may fold the battery cells 110 or at least one electrode lead 120 so that the electrode assembly accommodation spaces 112 of the battery cells 110 adjacent to each other face or contact each other. In this case, at least one electrode lead 120 may include a plurality of electrode leads 120.

In some cases, the pad member 130 may be interposed between each of the plurality of battery cells 110. The folding device 220 may fold the plurality of electrode leads 120 by moving the plurality of battery cells 110 in a state in which the pad member 130 is interposed between each of the plurality of battery cells 110. However, the timing and method of interposing the pad member 130 between each of the plurality of battery cells 110 are not necessarily limited by the present disclosure.

With reference to FIGS. 1 to 17, as described above, the manufacturing apparatus of the battery apparatus 100 according to an embodiment of the present disclosure may include the welding device 210 welding the busbar member 141 to the plurality of electrode leads 120 of the plurality of battery cells 110 respectively including the plurality of electrode leads 120, and a folding device 220 folding the plurality of electrode leads 120 and stacking the plurality of battery cells 110 in the thickness direction of the plurality of battery cells 110.

Meanwhile, as another aspect, the present disclosure provides a manufacturing method of a battery apparatus. FIG. 18 schematically illustrates a manufacturing method of a battery apparatus according to an embodiment of the present disclosure.

As shown in FIG. 1, FIG. 2, and FIG. 18, the manufacturing method of a battery apparatus 100 according to an embodiment of the present disclosure may include a welding operation (S110) of welding a busbar member 141 to a plurality of battery cells 110 respectively including a plurality of electrode leads 120, and a folding operation (S120) of moving at least one battery cell 110 to bend at least one of the plurality of electrode leads 120, and stacking the plurality of battery cells 110 in the thickness direction of the plurality of battery cells 110.

The welding operation (S110) may be performed in a state in which the plurality of battery cells 110 are arranged in a row in the width direction (Y-direction) of the battery cells 110. The welding operation (S110) may include an operation of performing laser welding.

The welding operation (S110) may weld the cathode leads 121 of the plurality of adjacent battery cells 110 to the first bus bar member 241, and may weld the anode leads 122 of the plurality of battery cells 110 to the second bus bar member 341.

The welding operation (S110) may include a plurality of welding processes.

The folding operation (S120) may be performed after the completion of the welding operation (S110). The folding operation (S120) may move at least one battery cell 110 to bend the plurality of electrode leads 120 that have been welded to a first bus bar member 241. The plurality of electrode leads 120 may be bent in opposite directions. Additionally, the plurality of electrode leads 120 may be bend in a direction that brings the electrode leads 120 closer to each other. This may be applied to the second busbar member 341 with the same principle.

The folding operation (S120) may include a plurality of folding processes. The folding process may be a process of moving the battery cells 110 to bend the electrode leads 120.

The folding operation (S120) may move the plurality of battery cells 110 so that the electrode leads 120 of all the plurality of battery cells 110 are bent.

After the completion of the folding operation (S120) or during the implementation of the folding operation (S120), the plurality of battery cells 110 may be stacked (or laminated) or arranged in the thickness direction of the battery cells 110. After the completion of the folding operation (S120), a battery cell assembly comprised of the plurality of battery cells 110 may be manufactured.

The contents described above are merely examples of applying the principles of the present disclosure, and other components may be further included or substituted and applied without departing from the scope of the present disclosure.

What is claimed is:

1. A battery apparatus, comprising:
a plurality of battery cells respectively including a plurality of electrode leads;
a busbar assembly connected to the plurality of electrode leads of the plurality of battery cells; and
a case covering the plurality of battery cells and the busbar assembly,
wherein the busbar assembly includes:
a busbar member in contact with the plurality of electrode leads; and
an insulating member in which one surface thereof is in contact with the busbar member and the other surface faces the case.

2. The battery apparatus of claim 1, wherein a contact region in which the busbar member is in contact with the plurality of electrode leads does not face the case.

3. The battery apparatus of claim 1, wherein the case and the busbar member are spaced apart from each other with the insulating member interposed therebetween.

4. The battery apparatus of claim 1, wherein the plurality of battery cells are arranged so that a plurality of electrode leads of one battery cell face a plurality of electrode leads of the other battery cell adjacent to the one battery cell, and
the busbar members are provided in plural,
wherein one busbar member is in contact with one electrode lead of the one battery cell and one electrode lead of the other battery cell.

5. The battery apparatus of claim 4, wherein the insulating members are provided in plural,
wherein one insulating member is in contact with one busbar member.

6. The battery apparatus of claim 5, wherein a plurality of busbar members are spaced apart from each other, and
wherein a plurality of insulating members are spaced apart from each other.

7. The battery apparatus of claim 2, wherein the busbar member includes:
a first body region including the contact region; and
a first extension region bent and extending from the first body region,
wherein the insulating member includes:
a second body region in contact with the first body region; and
a second extension region bent and extending from the second body region and supporting the first extension region.

8. The battery apparatus of claim 7, further comprising:
a sensing assembly in contact with the first extension region.

9. The battery apparatus of claim 8, the sensing assembly includes:
a sensing terminal in contact with the first extension region; and
a substrate connected to the sensing terminal, and disposed so that at least a partial region thereof faces a side sealing portion of the plurality of battery cells.

10. The battery apparatus of claim 7, wherein the insulating member further includes:
a third extension region bent and extending from the second body region, and spaced apart from the second extension region to face the second extension region,
wherein the insulating member further includes:
a fastening member connecting the third extension region and the case.

11. The battery apparatus of claim 10, wherein the insulating member further includes:
a through-hole formed in the third extension region; and
an insulating ring inserted into the through-hole and including a hollow portion,
wherein the fastening member is fixed to the case by penetrating through the hollow portion of the insulating ring.

12. The battery apparatus of claim 1, wherein the plurality of battery cells are provided so that the plurality of electrode leads are bent.

13. The battery apparatus of claim 1, wherein the busbar assembly further includes:
an outer busbar member in contact with an electrode lead of a battery cell disposed in an outermost portion of one side, among the plurality of battery cells, and an electrode lead of a battery cell disposed in an outermost portion of the other side; and
a side insulating member supporting the outer busbar member.

14. A manufacturing apparatus of a battery apparatus, comprising:
a welding device welding an electrode lead of one battery cell, among a plurality of battery cells, and an electrode lead of the other battery cell to a busbar member; and
a folding device including a jig member disposed to face the electrode lead of the one battery cell and the electrode lead of the other battery cell, and moving at least one of the one battery cell or the other battery cell.

15. The manufacturing apparatus of a battery apparatus of claim 14, wherein the folding device moves at least one of the one battery cell or the other battery cell so that the electrode lead of the one battery cell and the electrode lead of the other battery cell are in contact with the jig member.

16. The manufacturing apparatus of a battery apparatus of claim 14, wherein the folding device moves at least one of the one battery cell or the other battery cell so that the one battery cell and the other battery cell are adjacent to each other.

17. The manufacturing apparatus of a battery apparatus of claim 14, wherein a width of the jig member is widest on a surface in contact with the electrode lead and is reduced in a direction away from the electrode lead.

18. A manufacturing method of a battery apparatus, comprising:
a welding operation of welding a busbar member to a plurality of battery cells respectively including a plurality of electrode leads; and
a folding operation of moving at least one battery cell to bend at least one of the plurality of electrode leads, and stacking the plurality of battery cells in a thickness direction of the plurality of battery cells.
